(19) United States
(12) Patent Application Publication
(10) Pub. No.: US 2018/0139668 A1
(43) Pub. Date: May 17, 2018

(54) TERMINAL DEVICE, BASE STATION APPARATUS, INTEGRATED CIRCUIT, AND WIRELESS COMMUNICATION METHOD

(71) Applicant: Sharp Kabushiki Kaisha, Sakai City, Osaka (JP)

(72) Inventors: Hiroki TAKAHASHI, Sakai City, Osaka (JP); Tatsushi AIBA, Sakai City, Osaka (JP); Shoichi SUZUKI, Sakai City, Osaka (JP); Kazunari YOKOMAKURA, Sakai City, Osaka (JP); Yasuyuki KATO, Sakai City, Osaka (JP)

(73) Assignee: Sharp Kabushiki Kaisha, Sakai City, Osaka (JP)

(21) Appl. No.: 15/501,107

(22) PCT Filed: Aug. 5, 2015
(86) PCT No.: PCT/JP2015/072237

§ 371 Date: Feb. 1, 2017

(30) Foreign Application Priority Data
Aug. 5, 2014 (JP) 2014-159390

(51) Int. Cl. H04W 36/02; H04W 72/12; H04W 74/08; H04W 92/18; H04W 92/10; H04W 76/11

(52) U.S. Cl. CPC H04W 36/026; H04W 72/1294; H04W 74/0833; H04W 4/70; H04W 92/10; H04W 76/11; H04W 92/18

(57) ABSTRACT

In a terminal device that communicates with a different terminal device and a base station apparatus, in a case where data that is available for transmission to the different terminal device is retained in a buffer, processing is performed in such a manner that information indicating a C-RNTI is included in a message 3 that is to be transmitted to the base station apparatus.

### TECHNICAL FIELD

The present invention relates to a terminal device, a base station apparatus, an integrated circuit, and a wireless communication method.

This application claims the benefit of Japanese Patent Application No. 2014-159390 filed on Aug. 5, 2014, the entire contents of which are incorporated herein by reference.

### BACKGROUND ART

In the 3rd Generation Partnership Project (3GPP), a radio access scheme (Evolved Universal Terrestrial Radio Access (EUTRA)) and a radio access network (Evolved Universal Terrestrial Radio Access Network (EUTRAN)) for cellular mobile communication have been considered. The EUTRA and the EUTRAN are also referred to as Long Term Evolution (LTE). In LTE, a base station apparatus is also referred to as an evolved NodeB (eNodeB) and a terminal device is also referred to as a User Equipment (UE). LTE is a cellular communication system in which an area is divided in a cellular pattern into multiple cells, each being served by a base station apparatus. A single base station apparatus may manage multiple cells.

In 3GPP, Proximity based Services (ProSe) have been considered. ProSe includes ProSe discovery and ProSe communication. The ProSe discovery is a process which specifies that a terminal device is brought in proximity to a different terminal device using the EUTRA. The ProSe communication is communication between two terminal devices that are brought in proximity to each other using a EUTRAN communication path that is established between the two terminals. For example, the communication path may be established directly between the terminal devices.

The ProSe discovery and the ProSe communication are also referred to as Device to Device (D2D) discovery and D2D communication, respectively. The ProSe discovery and the ProSe communication are also collectively referred to as ProSe. The D2D discovery and the D2D communication are also collectively referred to as D2D. Therefore, in describing the present invention, what is referred to as D2D may be preferred to as ProSe, and what is referred to as ProSe may be referred to as D2D. The communication path is also referred to as a link.

In NPL 1, it is disclosed that a subset of resource blocks is reserved for the D2D, that a network configures a set of D2D resources, and that the terminal device is allowed to transmit a D2D signal using the configured resources.

### CITATION LIST

### Non Patent Literature

NPL 1: “D2D for LTE Proximity Services: Overview”, R1-132028, 3GPP TSG-RAN WG1 Meeting #73, 20-24 May 2013

### SUMMARY OF INVENTION

### Technical Problem

However, it has not been sufficiently considered that the terminal device performs the D2D and cellular communication at the same time. Several aspects of the present invention are provided in view of the problem described above. An object of the present invention is to provide a terminal device that is capable of efficiently performing D2D, a base station apparatus that controls the terminal device, an integrated circuit that is built into the terminal device, a base station apparatus that is used in the base station apparatus, a communication method that is used in the terminal device, and a communication method that is used in the base station apparatus.

### Solution to Problem

(1) In order to accomplish the object described above, the following means are contrived according to several aspects of the present invention. That is, according to an aspect of the present invention, there is provided a terminal device that communicates with a different terminal device and a base station apparatus, comprising: a transmission unit that transmits a signal to the different terminal device and the base station apparatus; a reception unit that receives the signal from the base station apparatus; a buffer that retains data which is transmitted from the transmission unit; and a higher layer processing unit that processes a random access procedure, in which the transmission unit transmits a random access preamble to the base station apparatus, and in which, in a case where a random access response that corresponds to the random access preamble is received with the reception unit, and where data that is available for transmission to the different terminal device is retained in the buffer, the higher layer processing unit performs processing in such a manner that information indicating a C-RNTI is included in a message 3 that is to be transmitted from the transmission unit to the base station apparatus, on a Physical Uplink Shared Channel that corresponds to the random access response.

(2) Furthermore, in the terminal device according to the aspect of the present invention, in the case where the random access response that corresponds to the random access preamble is received in the reception unit, and where the data that is available for the transmission to the different terminal device is retained in the buffer, the higher layer processing unit may perform processing in such a manner that information indicating a D2D group ID is included in the message 3.

(3) Furthermore, in the terminal device according to the aspect of the present invention, in the case where the random access response that corresponds to the random access preamble is received in the reception unit, and where the data that is available for the transmission to the base station apparatus is retained in the buffer, the higher layer processing unit may perform processing in such a manner that the information indicating the C-RNTI is included in the message 3.

(4) Furthermore, in the terminal device according to the aspect of the present invention, in a case where a Physical Downlink Control Channel destined for a destination of the C-RNTI is detected from the signal that is received from the reception unit, and where the Physical Downlink Control Channel includes an uplink grant for new transmission, the higher layer processing unit may end a random access procedure.

(5) Furthermore, in the terminal device according to the aspect of the present invention, in a case where a Physical Downlink Control Channel destined for a destination of the C-RNTI is detected from the signal that is received from the reception unit, and where the Physical Downlink Control Channel includes a D2D grant that belongs to the D2D group ID, the higher layer processing unit may end a random access procedure.

(6) Furthermore, according to another aspect of the present invention, there is provided a base station apparatus that communicates with a terminal device, including: a reception unit that receives a message 3 which includes pieces of information indicating a C-RNTI and a D2D group ID, respectively, from the terminal device; a higher layer processing unit that performs processing in such a manner that a Physical Downlink Control Channel destined for a destination of the C-RNTI includes an uplink grant for new transmission; and a transmission unit that transmits the Physical Downlink Control Channel to the terminal device.

(7) Furthermore, according to still another aspect of the present invention, there is provided an integrated circuit that is built into a terminal device that communicates with a different terminal device and a base station apparatus, causing the terminal device to perform a sequence of functions including: a function of transmitting a signal to the different terminal device and the base station apparatus; a function of receiving the signal from the base station apparatus; a function of retaining data that is transmitted to the different terminal device and the base station apparatus; and a function of processing a random access procedure, in which a random access preamble is transmitted to the base station apparatus, and in which, in a case where a random access response that corresponds to the random access preamble is received, and where data that is available for transmission to the different terminal device is retained, processing is performed in such a manner that information indicating a C-RNTI is included in a message 3 that is to be transmitted to the base station apparatus, on a Physical Uplink Shared Channel that corresponds to the random access response.

(8) Furthermore, in the integrated circuit according to the aspect of the present invention, in a case where a Physical Downlink Control Channel destined for a destination of the C-RNTI is detected from the signal that is received from the base station apparatus, and where the Physical Downlink Control Channel includes an uplink grant for new transmission, a random access procedure may be ended.

(9) Furthermore, according to still another aspect of the present invention, there is provided an integrated circuit that is built into a base station apparatus that communicates with a terminal device, causing the base station apparatus to perform a sequence of functions including: a function of receiving a message 3 that includes information indicating a C-RNTI, from the terminal device; a function of performing processing in such a manner that a Physical Downlink Control Channel destined for a destination of the C-RNTI includes an uplink grant for new transmission; and a function of transmitting the Physical Downlink Control Channel to the terminal device.

(10) Furthermore, according to still another aspect of the present invention, there is provided a wireless communication method that is used in a terminal device that communicates with a different terminal device and a base station apparatus, including: retaining data that is to be transmitted to the different terminal device and the base station apparatus; transmitting a random access preamble to the base station apparatus; and performing processing in such a manner that, in a case where a random access response that corresponds to the random access preamble is received and where data that is available for transmission to the different terminal device is retained, information indicating a C-RNTI is included in a message 3 that is to be transmitted to the base station apparatus, on a Physical Uplink Shared Channel that corresponds to the random access response.

(11) Furthermore, in the wireless communication method according to the aspect of the present invention, in a case where a Physical Downlink Control Channel destined for a destination of the C-RNTI is detected from the signal that is received from the base station apparatus, and where the Physical Downlink Control Channel includes an uplink grant for new transmission or a D2D grant, a random access procedure may be ended.

(12) Furthermore, according to still another aspect of the present invention, there is provided a wireless communication method that is used in a base station apparatus that communicates with a terminal device, including: receiving a message 3 that includes information indicating a C-RNTI and information indicating a D2D group ID, from the terminal device; performing processing in such a manner that a Physical Downlink Control Channel destined for a destination of the C-RNTI includes an uplink grant for new transmission; and transmitting the Physical Downlink Control Channel to the terminal device.

### Advantageous Effects of Invention

According to several aspects of the invention, a terminal device is capable of efficiently performing D2D, and a base station apparatus is capable of controlling the terminal device.

### BRIEF DESCRIPTION OF DRAWINGS

FIG. 1 is a conceptual diagram of a wireless communication system according to an embodiment of the present invention.

FIG. 2 is a diagram illustrating a schematic constitution of a radio frame according to the embodiment of the present invention.

FIG. 3 is a diagram illustrating a constitution of a slot according to the embodiment of the present invention.

FIG. 4 is a diagram illustrating a D2D resource according to the present embodiment.

FIG. 5 is a diagram illustrating one example of a constitution of a MAC PDU according to the embodiment of the present invention.

FIG. 6 is a diagram illustrating one example of a constitution of a C-RNTI MAC CE according to the embodiment of the present invention.

FIG. 7 is a diagram illustrating one example of the constitution of the C-RNTI MAC CE according to the embodiment of the present invention.

FIG. 8 is a diagram illustrating one example of the constitution of the C-RNTI MAC CE according to the embodiment of the present invention.

FIG. 9 is a diagram illustrating one example of a constitution of a BSR MAC CE that uses a Short BSR according to the embodiment of the present invention.

FIG. 10 is a diagram illustrating one example of the constitution of the BSR MAC CE that uses a long BSR according to the embodiment of the present invention.

FIG. 11 is a diagram illustrating one example of a constitution of a D2D BSR MAC CE according to the embodiment of the present invention.

FIG. 12 is a diagram illustrating information that is associated with a random access procedure according to the embodiment of the present invention.

FIG. 13 is a flow diagram illustrating a procedure for an operational example 1 of a terminal device 1 according to the embodiment of the present invention.

FIG. 14 is a flow diagram illustrating a procedure for an operational example 2 that is another operational example of the terminal device 1 according to the present embodiment.

FIG. 15 is a flow diagram illustrating a procedure for an operational example 3 that is another operational example of the terminal device 1 according to the present embodiment.

FIG. 16 is a flow diagram illustrating a procedure for an operational example 4 that is another operational example of the terminal device 1 according to the present embodiment.

FIG. 17 is a flow diagram illustrating a procedure for an operational example 5 that is another operational example of the terminal device 1 according to the present embodiment.

FIG. 18 is a schematic block diagram illustrating a constitution of the terminal device 1 according to the embodiment of the present invention.

FIG. 19 is a schematic block diagram illustrating a constitution of a base station apparatus 3 according to the embodiment of the present invention.

### DESCRIPTION OF EMBODIMENTS

Embodiments of the present invention will be described below.

According to the present embodiment, one or multiple cells are configured for a terminal device. A technology in which the terminal device performs communication through multiple cells is referred to as cell aggregation or carrier aggregation. The present invention may apply to each of the multiple cells that are configured for the terminal device. Furthermore, the present invention may apply to some of the multiple cells that are configured. A cell that is configured for the terminal device is referred to as a serving cell. The serving cell is used for communication for a EUTRAN. A cell that is configured for D2D is referred to as a D2D cell. The D2D cell may be the serving cell. Furthermore, the D2D cell may be a cell other than the serving cell.

Multiple serving cells that are configured include one primary cell, or one or multiple secondary cells. A primary cell is a serving cell in which an initial connection establishment procedure is executed, a serving cell in which a connection re-establishment procedure is started, or a cell that is designated as a primary cell during a handover procedure. At a point in time at which a Radio Resource Control (RRC) connection is established, or later, the secondary cell may be configured.

In the case of the cell aggregation, a Time Division Duplex (TDD) scheme or a Frequency Division Duplex (FDD) scheme may apply to all multiple cells. Furthermore, a cell to which the TDD scheme applies and a cell to which the FDD scheme applies may be aggregated.

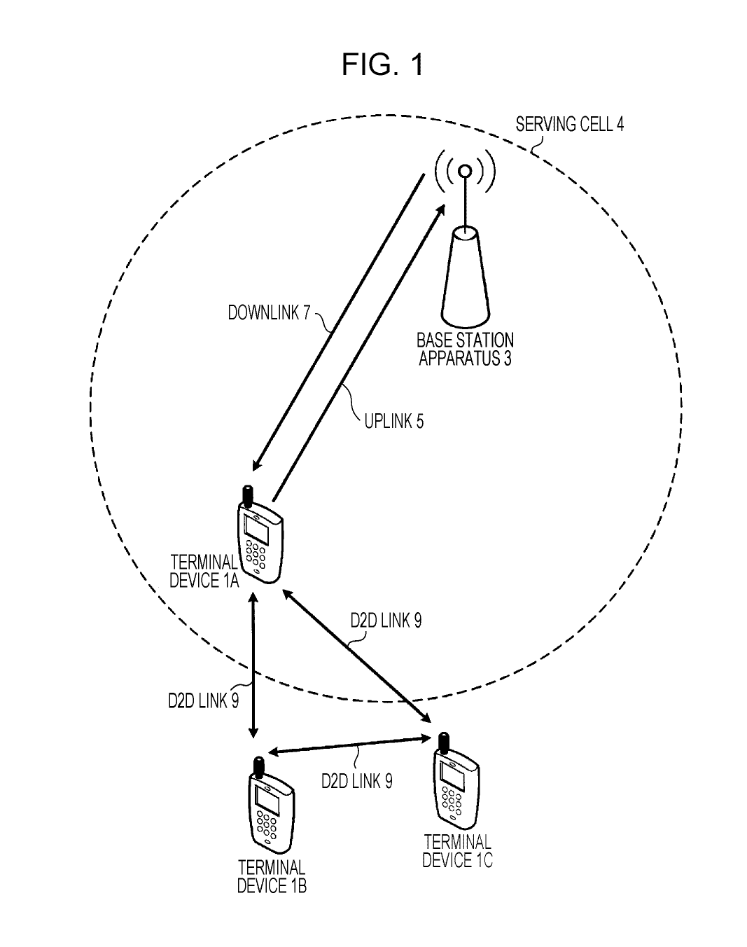

FIG. 1 is a conceptual diagram of a wireless communication system according to the present embodiment. In FIG. 1, the wireless communication system includes terminal devices 1A to 1C and a base station apparatus 3. The terminal devices 1A to 1C are referred to as a terminal device 1. A serving cell 4 indicates an area (coverage) that is covered by the base station apparatus 3 (LTE or the EUTRAN). The terminal device 1A is in EUTRAN coverage. The terminal device 1B and the terminal device 1C are out of the EUTRAN coverage.

An uplink 5 is a link from the terminal device 1 to the base station apparatus 3. Moreover, in the uplink 5, a signal may be transmitted directly from the terminal device 1 to the base station apparatus 3 without involving the repeater. A downlink 7 is a link from the base station apparatus 3 to the terminal device 1. Furthermore, the uplink 5 and the downlink 7 are also referred to as a cellular link or a cellular communication path. Furthermore, communication between the terminal device 1 and the base station apparatus 3 is also referred to cellular communication or communication with the EUTRAN.

A D2D link 9 is a link between the terminal devices 1. Moreover, the D2D link 9 is also referred to as a D2D communication path, a ProSe link, or a ProSe communication path. D2D discovery and D2D communication are performed over the D2D link 9. The D2D discovery is a process/procedure which specifies that the terminal device 1 is brought in proximity to a different terminal device 1 using a EUTRA. The D2D communication is communication between multiple terminal devices 1 that are brought in proximity to one another using a EUTRAN communication path that is established between the multiple terminal devices 1. For example, the communication path may be established directly between the terminal devices 1.

A physical channel and a physical signal according to the present embodiment are described.

A downlink physical channel and a downlink physical signal are collectively referred to as a downlink signal. An uplink physical channel and an uplink physical signal are collectively referred to as an uplink signal. A D2D physical channel and a D2D physical signal are collectively referred to as a D2D signal. The physical channel is used for transmitting information that is output from a higher layer. The physical signal is not used for transmitting the information that is output from the higher layer, but is used by a physical layer.

In FIG. 1, the following D2D physical channels are used for wireless communication over the D2D link 9 between the terminal devices 1.

Physical Device to Device Synchronization Channel (PD2DSCH)

Physical Device to Device Data Channel (PD2DDCH)

The PD2DSCH is used for information relating to synchronization. For example, the information relating to the synchronization includes a D2D frame number or a System Frame Number (SFN).

The PD2DDCH is used for transmitting D2D data (a Prose communication Shared Channel (PSCH)) and Device to Device Scheduling Assignment (D2DSA). The D2D data and the D2DSA are not mapped to the same PD2DSCH. The D2DSA is used for scheduling of the PD2DSCH that is used for transmission of the D2D data. The D2DSA includes information indicating a resource for the PD2DSCH that is used for the transmission of the D2D data, information indicating destination identity, information indicating source identity, and the like. The D2D data and the D2DSA that correspond to the D2D discovery are referred to as a discovery signal. The D2D data and the D2DSA that correspond to the D2D communication are referred to as a communication signal.

The PD2DSCH may be a Physical Uplink Shared Channel (PUSCH). That is, the PUSCH may be used for transmission of the D2D data and the D2DSA. According to the present embodiment, the PUSCH that is used for the D2D is referred to as the PD2DSCH. According to the present embodiment, the PUSCH that is used for the communication with the EUTRAN is simply expressed as the PUSCH. The PUSCH will be described in detail below.

In FIG. 1, the following D2D physical signals are used for D2D wireless communication.

D2D Synchronization Signal (D2DSS)

D2D Reference Signal (D2DRS)

The D2DSS is used for being synchronized in a D2D link. The D2DSS includes a Primary D2D Synchronization Signal (PD2DSS) and a Secondary D2D synchronization Signal (SD2DSS). The D2DSS is associated with transmission of the PD2DSCH. The D2DSS may be time-multiplexed with the PD2DSCH. The terminal device 1 may use the D2DSS in order to perform channel reconfiguration of the PD2DSCH.

The D2DRS is associated with transmission of the PD2DSCH or the PD2DDCH. The D2DRS may be time-multiplexed with the PUSCH or PUCCH. The terminal device 1 may use the D2DRS in order to perform the channel reconfiguration of the PD2DSCH.

From the perspective of the terminal device 1 that performs transmission, the terminal device 1 can operate in two modes (a mode 1 and a mode 2) for allocation of a resource to the D2D communication.

In the mode 1, the EUTRAN (the base station apparatus 3) schedules a correct resource that is used by the terminal device 1 for transmission of the communication signal (the D2D data and the D2DSA).

In the mode 2, the terminal device 1 selects a resource from a resource for transmission of the transmission signal (the D2D data and the D2DSA). The resource pool is a set of resources. A resource pool for the mode 2 may be configured/limited semi-statically by the EUTRAN (the base station apparatus 3). Furthermore, the resource pool for the mode 2 may be pre-configured.

The terminal device 1 that has the capability of the D2D communication, which is in the EUTRAN coverage, may support the mode 1 and the mode 2. The terminal device 1 that has the capability of the D2D communication, which is out of the EUTRAN coverage, may support only the mode 2.

Two types (a type 1 and a type 2) of D2D discovery procedures are defined.

The type 1 of D2D discovery procedure is a D2D discovery procedure in which a resource for the discovery signal is not dedicatedly allocated to the terminal device 1. That is, in the type 1 of D2D discovery procedure, the resource for the discovery signal may be allocated to all terminal devices 1 or a group of terminal devices 1.

The type 2 of D2D discovery procedure is a D2D discovery procedure in which the resource for the discovery signal is dedicatedly allocated to the terminal device 1. The discovery procedure in which a resource is allocated to each of the transmission instances dedicated to the discovery signal is referred to as a type 2A discovery procedure. The type 2 of discovery procedure in which a resource is allocated semi-persistently for the transmission of the discovery signal is referred to as a type 2B discovery procedure.

In FIG. 1, the following uplink physical channels are used for uplink wireless communication.

Physical Uplink Control Channel (PUCCH)

Physical Uplink Shared Channel (PUSCH)

Physical Random Access Channel (PRACH)

The PUCCH is a physical channel that is used for transmitting Uplink Control Information (UCI).

The PUSCH is a physical channel that is used for transmitting uplink data (Uplink-Shared Channel (UL-SCH)) and/or a HARQ-ACK and/or channel state information.

The PRACH is a physical channel that is used for transmitting a random access preamble. The PRACH is used for the initial connection establishment procedure, the handover procedure, and the connection re-establishment procedure.

In FIG. 1, the following uplink physical signal is used for the uplink wireless communication.

Uplink Reference Signal (UL RS)

According to the present embodiment, the following two types of uplink reference signals are used.

Demodulation Reference Signal (DMRS)

Sounding Reference Signal (SRS)

The DMRS is associated with transmission of the PUSCH or the PUCCH. The DMRS is time-multiplexed with the PUSCH or the PUCCH. The base station apparatus 3 uses the DMRS in order to perform the channel reconfiguration of the PUSCH or the PUCCH. The SRS is not associated with the transmission of the PUSCH or the PUCCH. The base station apparatus 3 uses the SRS in order to measure an uplink channel state.

In FIG. 1, the following downlink physical channels are used for downlink wireless communication.

Physical Broadcast Channel (PBCH)

Physical Control Format Indicator Channel (PCFICH)

Physical Hybrid automatic repeat request Indicator Channel (PHICH)

Physical Downlink Control Channel (PDCCH)

Enhanced Physical Downlink Control Channel (EPDCCH)

Physical Downlink Shared Channel (PDSCH)

Physical Multicast Channel (PMCH)

The PBCH is used for broadcasting a Master Information Block (MIB) (Broadcast Channel (BCH)) that is used in a shared manner in the terminal device 1. For example, the MIB includes information indicating the SFN. The system frame number (SFN) is a radio frame number. The MIB is system information.

The PCFICH is used for transmitting information that indicates a region (an OFDM symbol) which is used for transmission of the PDCCH.

The PHICH is used for transmitting a HARQ indicator indicating an ACKnowledgement (ACK) of or a Negative ACKnowledgement (NACK) of the uplink data (the Uplink Shared Channel (UL-SCH)) that is received by the base station apparatus 3.

The PDCCH and the EPDCCH are used for transmitting Downlink Control Information (DCI). The Downlink Control Information is also referred to as a DCI format. The Downlink Control Information includes a downlink grant, an uplink grant, and a D2D grant. The downlink grant is also referred to as downlink assignment or downlink allocation.

The uplink grant is used for scheduling of a single PUSCH within a single cell. The uplink grant is used for the scheduling of a single PUSCH within a certain subframe. The downlink grant is used for the scheduling of a single PDSCH within a single cell. The downlink grant is used for the scheduling of the PDSCH within a subframe that is the same as the subframe in which the downlink grant is transmitted. The D2D grant is used for scheduling of the PD2DDCH that is associated with the mode 1 for the D2D communication.

A Cyclic Redundancy Check (CRC) parity bit is attached to the DCI format. The CRC parity bit is scrambled with a Cell-Radio Network Temporary Identifier (C-RNTI), a Semi Persistent Scheduling Cell-Radio Network Temporary Identifier (SPS C-RNTI), or a D2D-Radio Network Temporary Identifier (D2D-RNTI) (which is also referred to as ProSe-RNTI). The C-RNTI, the SPS C-RNTI, and the D2D-RNTI are identifiers for identifying the terminal device 1 within a cell. The C-RNTI is used for controlling a resource for the PDSCH or a resource for the PUSCH within a single subframe. The SPS C-RNTI is used for periodically allocating a resource for the PDSCH or the PUSCH. The D2D-RNTI is used for transmission of the D2D grant. That is, the D2D-RNTI is used for the scheduling of the PD2DSCH for the D2D communication in the mode 1.

The PDSCH is used for transmitting downlink data (Downlink Shared Channel (DL-SCH)).

The PMCH is used for transmitting multicast data (Multicast Channel (MCH)).

In FIG. 1, the following downlink physical signals are used for the downlink wireless communication.

Synchronization signal (SS)

Downlink Reference Signal (DL RS)

The synchronization signal is used in order for the terminal device 1 to be synchronized to a frequency domain and a time domain for downlink. In the FDD scheme, the synchronization signal is mapped to subframes 0 and 5 within a radio frame.

The downlink reference signal is used in order for the terminal device 1 to perform the channel reconfiguration of the downlink physical channel. The downlink reference signal is used in order for the terminal device 1 to calculate downlink channel state information. The downlink reference signal is used in order for the terminal device 1 to measure a geographical location of the terminal device 1 itself.

According to the present embodiment, the following five types of downlink reference signals are used.

Cell-specific Reference Signal (CRS)

UE-specific Reference Signal (URS) that is associated with the PDSCH

Demodulation Reference Signal (DMRS) that is associated with the EPDCCH

Non-Zero Power Chanel State Information-Reference Signal (NZP CSI-RS)

Zero Power Chanel State Information-Reference Signal (ZP CSI-RS)

Multimedia Broadcast and Multicast Service over Single Frequency Network Reference signal (MBSFN RS)

The CRS is transmitted in an entire band for a subframe. The CRS is used for performing demodulation of the PBCH/PDCCH/PHICH/PCFICH/PDSCH. The CRS may be used in order for the terminal device 1 to calculate the downlink channel state information. The PBCH/PDCCH/PHICH/PCFICH is transmitted on an antenna port that is used for the transmission of the CRS.

The URS that is associated with the PDSCH is transmitted in a subframe and a band that are used for transmission of the PDSCH with which the URS is associated. The URS is used for performing the demodulation of the PDSCH with which the URS is associated. The PDSCH is transmitted on an antenna port that is used for the transmission of the CRS or on antenna port that is used for transmission of the URS.

The DMRS that is associated with the EPDCCH is transmitted in a subframe and a band that are used for transmission of the EPDCCH with which the DMRS is associated. The DMRS is used for performing demodulation of the EPDCCH with which the DMRS is associated. The EPDCCH is transmitted on an antenna port that is used for transmission of the DMRS.

The NZP CSI-RS is transmitted in a subframe that is configured. A resource on which the NZP CSI-RS is transmitted is configured by the base station apparatus 3. The NZP CSI-RS is used in order for the terminal device 1 to calculate the downlink channel state information. The terminal device 1 performs signal measurement (channel measurement) using the NZP CSI-RS.

A resource for the ZP CSI-RS is configured by the base station apparatus 3. With a zero output, the base station apparatus 3 transmits the ZP CSI-RS. More precisely, the base station apparatus 3 does not transmit the ZP CSI-RS. The base station apparatus 3 does not transmit the PDSCH and the EPDCCH on a resource that is configured for the ZP CSI-RS. For example, in a certain cell, the terminal device 1 can measure interference in a resource to which the NZP CSI-RS corresponds.

The MBSFN RS is transmitted in an entire band for a subframe that is used for transmission of the PMCH. The MBSFN RS is used for performing demodulation of the PMCH. The PMCH is transmitted on an antenna port that is used for transmission of the MBSFN RS.

The PSCH, the BCH, the MCH, the UL-SCH, and the DL-SCH are transport channels. A channel that is used in a Medium Access Control (MAC) layer is referred to as a transport channel. A unit of data for the transport channel that is used in the MAC layer is also referred to as a transport block (TB) or a MAC Protocol Data Unit (PDU). Control of a Hybrid Automatic Repeat reQuest (HARQ) is performed for every transport block in the MAC layer. The transport block is a unit of data that the MAC layer delivers to the physical layer. In the physical layer, the transport block is mapped to a codeword, and coding processing is performed on every codeword.

A structure of the radio frame according to the present embodiment is described.

In LTE, two structures of the radio frame are supported. The two structures of the radio frame are a frame structure type 1 and a frame structure type 2. The frame structure type 1 is applicable to FDD. The frame structure type 2 is applicable to TDD.

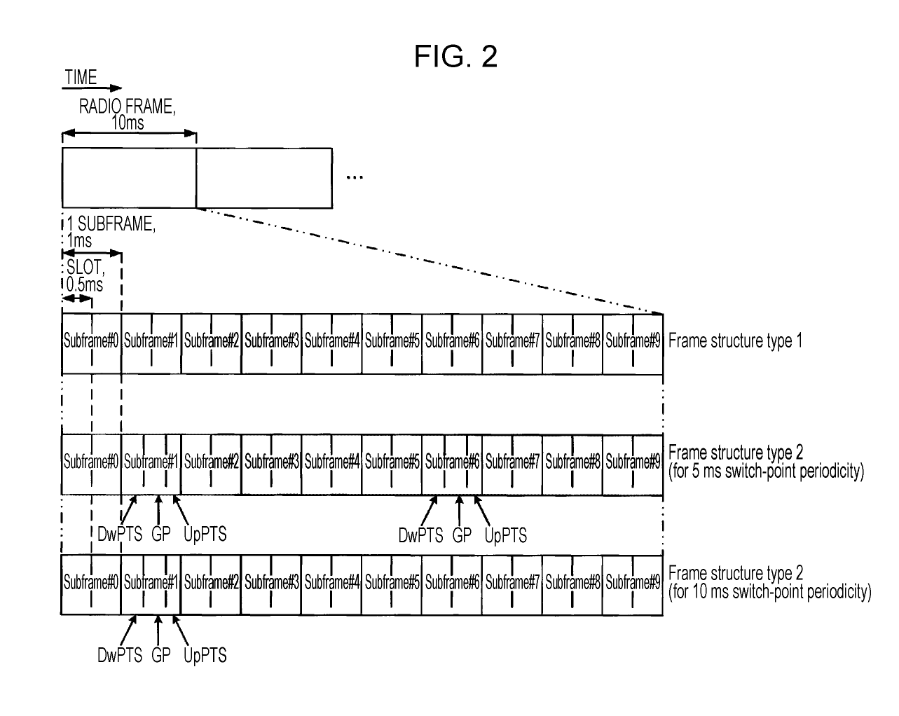

FIG. 2 is a diagram illustrating a schematic constitution of the radio frame according to the present embodiment. In FIG. 2, the horizontal axis is a time axis. Furthermore, each of a type 1 radio frame and a type 2 radio frame is 10 ms long, and is defined by 10 subframes. Each of the subframes is 1 ms long, and is defined by two consecutive slots. Each of the lots is 0.5 ms long. An i-th subframe within the radio frame is constituted from a (2×i)-th slot and a (2×i+1)-th slot.

The following three types of subframes are defined for frame structure type 2.

Downlink Subframe

Uplink Subframe

Special Subframe

The downlink subframe is a subframe that is reserved for downlink transmission. The uplink subframe is a subframe that is reserved for uplink transmission. The special subframe is constituted from three fields. The three fields are a Downlink Pilot Time Slot (DwPTS), a Guard Period (GP), and an Uplink Pilot Time Slot (UpPTS). A sum of lengths of the DwPTS, the GP, and the UpPTS is 1 ms long. The DwPTS is a field that is reserved for the downlink transmission. The UpPTS is a field that is reserved for the uplink transmission. The GP is a field on which the downlink transmission and the uplink transmission are not performed. Moreover, the special subframe may be constituted only from the DwPTS and the GP, and may be constituted only from the GP and the UpPTS.

A radio frame of frame structure type 2 is constituted at least from the downlink subframe, the uplink subframe, and the special subframe.

A constitution of the slot according to the present embodiment is described.

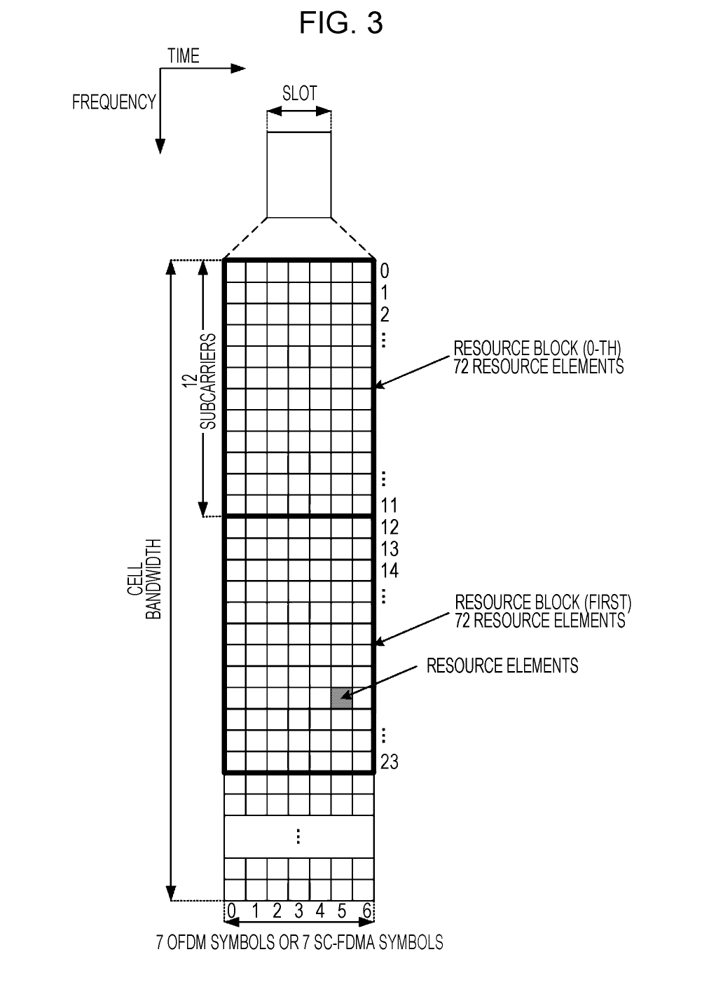

FIG. 3 is a diagram illustrating the constitution of the slot according to the present embodiment. In FIG. 3, a normal Cyclic Prefix (CP) applies to the OFDM symbol or an SC-FDMA symbol. The physical signal or the physical channel that is transmitted on each of the slots is expressed by a resource grid. In FIG. 3, the horizontal axis is a time axis and the vertical axis is a frequency axis. In a downlink, the resource grid is defined by multiple subcarriers and multiple OFDM symbols. In an uplink, the resource grid is defined by multiple subcarriers and multiple SC-FDMA symbols. For example, in the D2D link, the resource grid may be defined by multiple subcarriers and multiple SC-FDMA symbols. The number of subcarriers that constitute one slot depends on a cell bandwidth. The number of OFDM symbols or SC-FDMA symbols that constitute one slot is 7. Each of the elements within the resource grid is referred to as a resource element. The resource element is identified using a subcarrier number, and an OFDM symbol or SC-FDMA symbol number.

A resource block is used for expressing mapping of a certain physical channel (the PDSCH, the PUSCH, or the like) to resource elements. The resource block is defined by a virtual resource block and a physical resource block. A certain physical channel is first mapped to the virtual resource block. Thereafter, the virtual resource block is mapped to the physical resource block. One physical resource block is defined by 7 consecutive OFDM symbols or SC-FDMA symbols in the time domain and by 12 consecutive subcarriers in the frequency domain. Therefore, one physical resource block is constituted from (7×12) resource elements. Furthermore, one physical resource block corresponds to one slot in the time domain, and corresponds to 180 kHz in the frequency domain. The physical resource blocks are numbered from 0 in the frequency domain.

Moreover, an extended CP may apply to the OFDM symbol or the SC-FDMA symbol. In the case of the extended CP, the number of OFDM symbols or SC-FDMA symbols that constitute one slot is 7.

An arrangement of the physical channel and the physical signal according to the present embodiment is described.

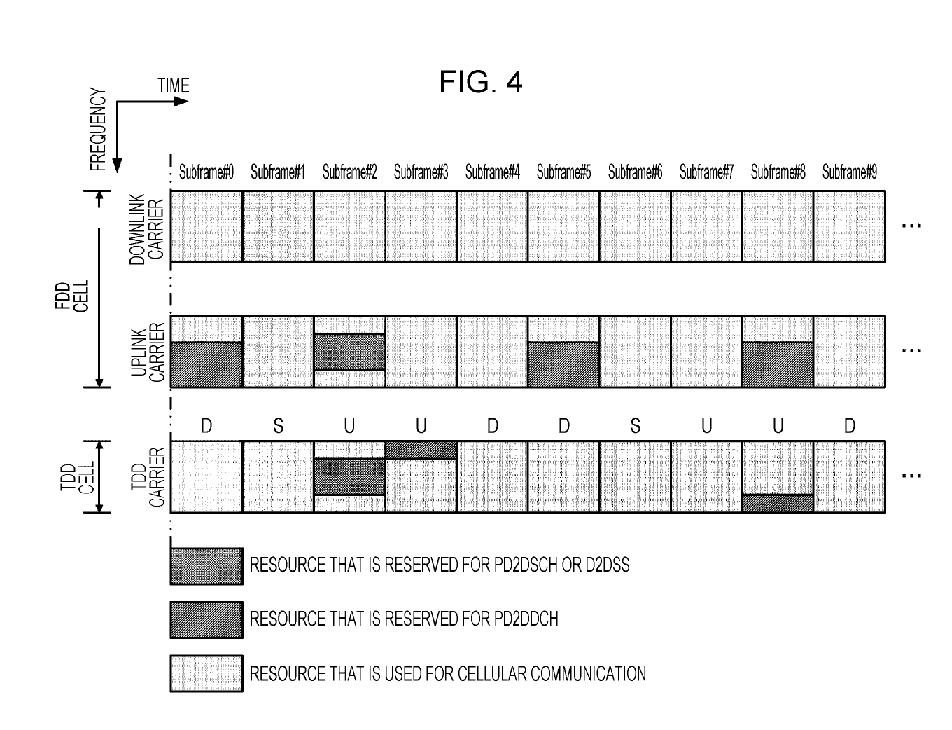

FIG. 4 is a diagram illustrating a D2D resource according to the present embodiment. A resource that is reserved for the D2D is referred to as the D2D resource. In FIG. 4, the horizontal axis is a time axis and the vertical axis is a frequency axis. In FIG. 4, D indicates a downlink subframe, S indicates a special subframe, and U indicates an uplink subframe. One FDD cell corresponds to one downlink carrier and one uplink carrier. One TDD cell corresponds to one TDD carrier.

In an FDD cell, the downlink signal that is used for the cellular communication is mapped to a subframe on a downlink carrier, the uplink signal that is used for the cellular communication is mapped to a subframe on an uplink carrier, and the D2D signal that is used for the D2D is mapped to a subframe on an uplink carrier. A carrier that corresponds to a cell in the downlink is referred to as a downlink component carrier. Furthermore, a carrier that corresponds to a cell in the uplink is referred to as an uplink component career. A TDD carrier is a downlink component carrier and is an uplink component carrier.

In a TDD cell, the downlink signal that is used for the cellular communication is mapped to the downlink subframe and the DwPTS, the uplink signal that is used for the cellular communication is mapped to the uplink subframe and the UpPTS, and the D2D signal that is used for the D2D is mapped to the uplink subframe and the UpPTS.

The base station apparatus 3 controls the D2D resource that is reserved for the D2D. The base station apparatus 3 reserves some of the resources on the uplink carrier in the FDD cell, as the D2D resource. The base station apparatus 3 reserves some of the resources in the uplink subframe and the UpPTS in the TDD cell, as the D2D resource.

The base station apparatus 3 may transmit a higher layer signal that includes information indicating a set (a pool) of D2D resources that are reserved in each of the cells, to the terminal device 1. The terminal device 1 sets a parameter, D2D-ResourceConfig, which indicates the D2D resource that is reserved for each of the cells, based on the higher layer signal that is received from the base station apparatus 3. That is, the base station apparatus 3 sets the parameter, D2D-ResourceConfig, which indicates the D2D resource that is reserved for each of the cells, for the terminal device 1 through the higher layer signal.

The PD2DSCH and the D2DSS is transmitted using 62 subcarriers in the vicinity of a center frequency of the uplink component carrier.

The base station apparatus 3 may set one or multiple parameters indicating one or multiple sets of resources that are reserved for the D2D, for the terminal device 1 through the higher layer signal.

A set of resources for the PD2DSCH and the D2DSS and a set of resources that are reserved for the PD2DDCH may be dedicatedly controlled.

A set of resources for each of the type 1 of D2D discovery, the type 2 of D2D discovery, the mode 1 for the D2D communication, and the mode 2 for the D2D communication may be dedicatedly configured.

A set of resources for D2D transmission and reception may be dedicatedly configured.

Additionally, a set of resources for the PD2DDCH relating to the transmission of the D2D data, and a set of resources for the PD2DDCH relating to the transmission of the D2DSA may be dedicatedly configured.

From the perspective of the terminal device 1, among the sets of resources, which are described above, one or several sets of resources may be transparent. For example, because the PD2DDCH for the D2D data for the D2D communication is scheduled by the D2DSA, the terminal device 1 may not configure a set of resources for reception/monitoring of the PD2DDCH relating to the D2D data for the D2D communication.

In 3GPP, it has been considered that the D2D is used for Public Safety (PS). The base station apparatus 3 may notify the terminal device 1 whether or not each of the sets of D2D resources is a set of resources for the PS. Furthermore, for the terminal device 1, the D2D for the PS may be authenticated through the EUTRAN. That is, the terminal device 1 for which the D2D for the PS is not authenticated has difficulty in performing the D2D with the set of resources for the PS.

A method of configuring a CP length according to the present embodiment is described.

The base station apparatus 3 controls CP lengths in the uplink and the downlink. The base station apparatus 3 may dedicatedly control the CP lengths in the uplink and downlink for every serving cell.

Based on the synchronization signal and/or the PBCH for a serving cell, the terminal device 1 detects a CP length of the downlink signal for the serving cell, with the exception of the PMCH and the MBSFN RS. The extended CP applies at all times to the PMCH and the MBSFN RS.

The base station apparatus 3 transmits to the terminal device 1 the higher layer signal that includes information indicating a CP length of the uplink signal in the serving cell. The terminal device 1 sets a parameter, UL-CyclicPrefixLength, which indicates the CP length in the uplink in the serving cell, based on the higher layer signal that is received from the base station apparatus 3. That is, the base station apparatus 3 sets the parameter, UL-CyclicPrefixLength, which indicates the CP length in the uplink in the serving cell, for the terminal device 1 through the higher layer signal.

The base station apparatus 3 may transmit to the terminal device 1 the higher layer signal that includes information indicating a CP length for the D2D. The terminal device 1 may set a parameter, D2D-CyclicPrefixLength, which indicates the CP length for the D2D, based on the higher layer signal that is received from the base station apparatus 3. That is, the base station apparatus 3 may set the parameter, D2D-CyclicPrefixLength, which indicates the CP length for the D2D, for the terminal device 1 through the higher layer signal.

CP lengths of the PD2DSCH and the D2DSS, and a CP length of the PD2DDCH may be dedicatedly configured.

A CP length for each of the type 1 of D2D discovery, the type 2 of D2D discovery, the mode 1 for the D2D communication, and the mode 2 for the D2D communication may be dedicatedly configured.

A CP length of the PD2DDCH relating to the transmission of the D2D data, and a CP length of the PD2DDCH relating to the transmission of the D2DSA may be dedicatedly configured.

That is, the CP lengths of the PD2DSCH and the D2DSS may be defined in advance with specifications or the like, and may be fixed. The CP length of the PD2DDCH relating to the transmission of the D2DSA may be defined in advance with specifications or the like, and may be fixed.

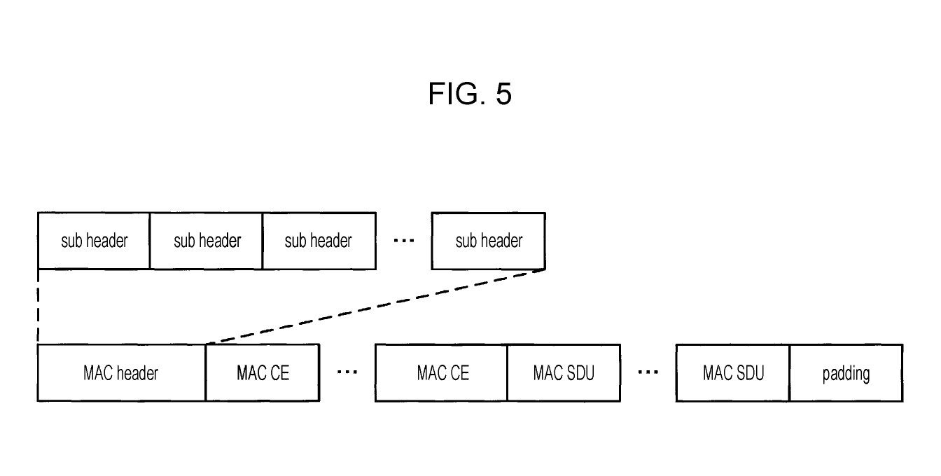

FIG. 5 illustrates one example of the MAC PDU according to the present embodiment. One MAC PDU is constituted from one MAC header, 0 or more MAC Service Data Units (MAC SDUs), 0 or more MAC Control Element (MAC CE), and padding.

The MAC header is constituted from multiple subheaders, and each subheader corresponds to the MAC SDU, the MAC CE, and the padding within the same MAC PDU. Included in the subheader is information or a parity bit, which, for example, is of a size of the corresponding MAC SDU or MAC CE, or a padding bit, if need arises, in addition to the corresponding MAC SDU or MAC CE, or what is indicated by a logical channel ID of padding.

The MAC CEs that are applicable in the MAC PDU which is mapped to the UL-SCH include a BSR MAC CE (which, in some cases, is referred to as a MAC BSR CE) for reporting a Buffer Status Report (BSR) for uplink, a D2D BSR MAC CE for reporting the BSR in the D2D link, a C-RNTI MAC CE for notifying the Cell-Radio Network Temporary Identifier (C-RNTI), a D2D-RNTI MAC CE for notifying the D2D-RNTI (which, in some case, is referred to as a D2D-Radio Network Temporary Identifier or a ProSe RNTI), and a PH MAC CE for reporting a Power Headroom (PH) (capacity available for transmit power). Furthermore, a D2D group ID MAC CE (a ProSe group ID MAC CE) for identifying a group of terminal devices 1 that constitute the D2D link may be included.

The BSR MAC CE is used for providing information relating to an amount of data available for transmission, which is included in an uplink buffer in the terminal device 1, to the base station apparatus 3. The D2D BSR MAC CE is used for providing the information relating to the amount of data available for transmission, which is included in a D2D buffer in the terminal device 1, to the base station apparatus 3. The BSR will be described below.

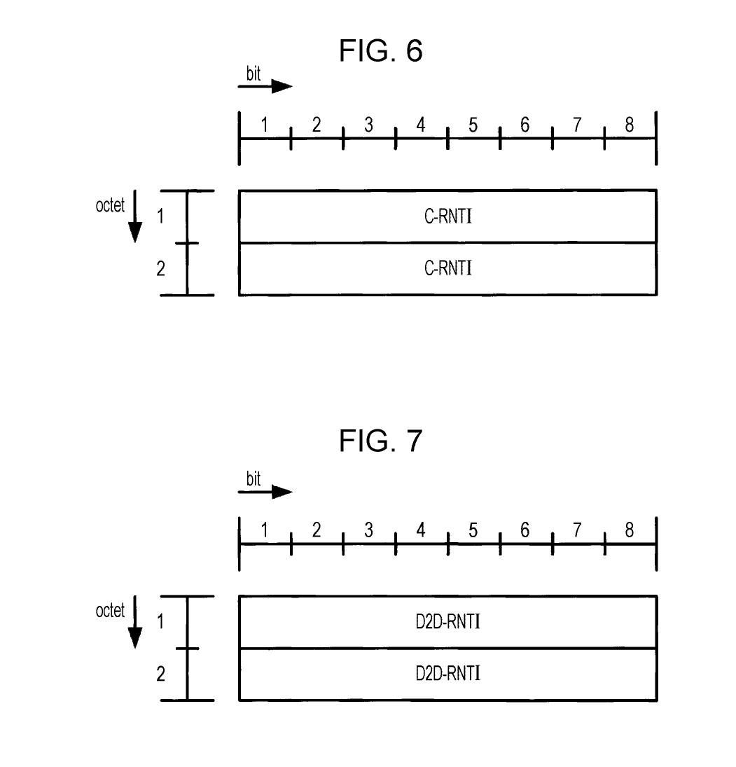

The C-RNTI MAC CE includes a C-RNTI for identifying the terminal device 1 within the serving cell in the cellular link. FIG. 6 is one example of a constitution of the C-RNTI MAC CE. The C-RNTI MAC CE is constituted from a C-RNTI field that includes a C-RNTI of the terminal device 1. The C-RNTI field is 16 bits (2 octets) long. The C-RNTI MAC CE is identified by the corresponding MAC PDU subheader.

The D2D-RNTI MAC CE includes a D2D-RNTI for identifying the terminal device 1 in the D2D link. FIG. 7 is one example of a constitution of the D2D-RNTI MAC CE. The D2D-RNTI MAC CE is constituted from a D2D-RNTI field that includes a D2D-RNTI of the terminal device 1. The D2D-RNTI field is 16 bits (2 octets) long. The D2D-RNTI MAC CE is identified by the corresponding MAC PDU subheader.

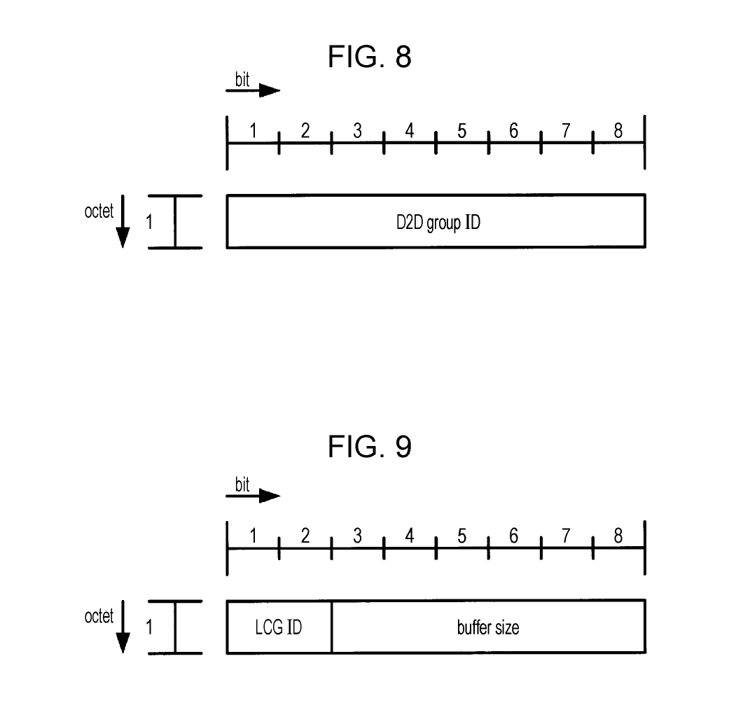

The D2D group ID MAC CE includes a D2D group ID for identifying a group of terminal devices 1 that perform the D2D communication. FIG. 8 is one example of a constitution of the D2D group ID MAC CE. The D2D group ID MAC CE is constituted from D2D group ID field that includes an ID for a D2D group to which the terminal device 1 belongs. The D2D group ID field 8 bits (1 octet) long. The D2D group ID MAC CE is identified by the corresponding MAC PDU subheader.

Next, the BSR according to the present embodiment will be described below.

In the uplink, a logical channel to which data that occurs is available for communication belongs is categorized as belong to any of the multiple logical channel group (LCG). With an uplink BSR, an amount of transmission data buffer for the uplink data that corresponds to each LCG is notified, as a message of the MAC layer, to the base station apparatus 3.

According to a triggering condition, the uplink BSRs includes a regular BSR, a periodic BSR, and a padding BSR.

In a case where data on a logical channel that belongs to a certain LCG is available for transmission, and where the data has a higher priority level than the logical channel that is already available for transmission, which belongs to any one of the LCGs, or in a case where data available for transmission is not present on the logical channel that belongs to any one of the LCGS, the regular BSR is triggered. Furthermore, in a case where a prescribed retransmission timer retx-BSR-Timer expires, and where the UE has data available for transmission on the logical channel that belongs to a certain LCG, the regular BSR is triggered.

In a case where a prescribed timer-periodic BSR-Timer expires, the periodic BSR is triggered.

In a case where the UL-SCH is allocated and where the number of padding bits is equal to or greater than sizes of the BSR MAC CE and a subheader thereof, the padding BSR is triggered.

Furthermore, a format for the MAC CE on which the uplink BSR is transmitted includes a Long BSR, a Short BSR, and a Truncated BSR.

FIG. 9 illustrates one example of a constitution of the BSR MAC CE that uses the Long BSR or the Short BSR in a case where the number of LCGs is 4. In FIG. 9, the Short BSR or the Truncated BSR is constituted from 8 bits (one octet), which are a sum of bits for a 2-bit LCG ID field indicating on which LCG the Buffer Status Report is and for a 6-bit buffer size field indicating a buffer size of the LCG, and it is possible that the Buffer Status Report on one LCG is transmitted.

The buffer size field indicates a total amount of available data that is delivered to all logical channels in the logical channel group after all MAC PDUs are built at a Transmission Time Interval (TTI).

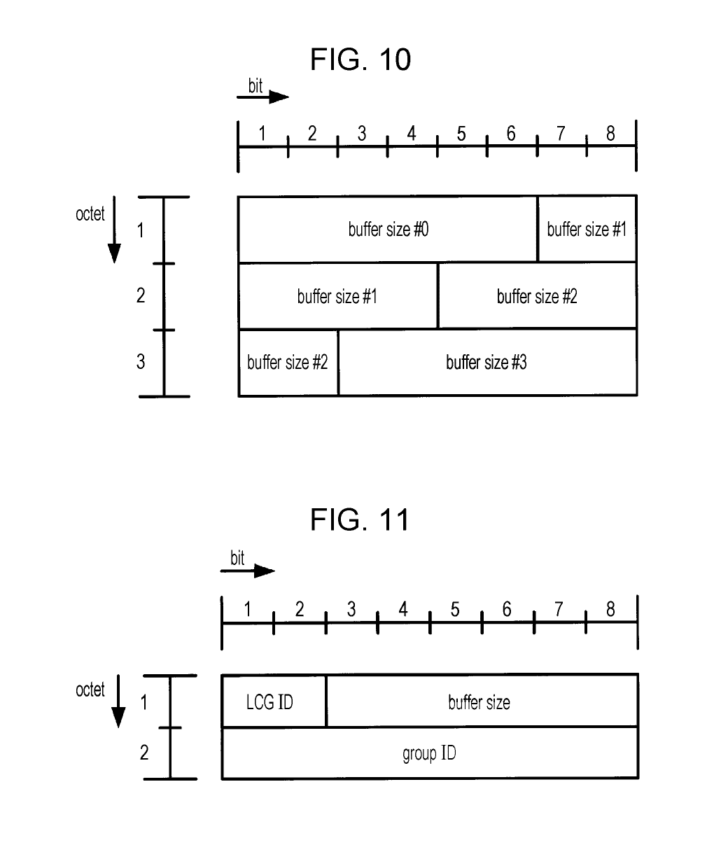

FIG. 10 indicates one example of a constitution of the BSR MAC CE that uses the long BSR in a case where the number of LCGs is 4. In FIG. 10, the Long BSR is constituted from 24 bits (3 octets), which are a sum of bits for four buffer size fields that indicate buffer sizes of LCGs that have LCG IDs #0 to #3, respectively, and it is possible that the Buffer Status Reports on all four LCGs are transmitted.

In a case where the regular BSR and the periodic BSR are performed, if data available for transmission on two or more LCGs is present at the TTI at which the BSR is transmitted, the terminal device 1 reports the Long BSR. In the other cases, the terminal device 1 reports the Short BSR.

In a case where the padding BSR is performed, if, at the TTI at which the BSR is transmitted, the number of padding bits is equal to or greater than sizes of a MAC CE on which the Long BSR is transmitted and of a subheader thereof, the terminal device 1 reports the Long BSR. In a case where the number of padding bits is less than the sizes of the MAC CE on which the Long BSR is transmitted and of a subheader thereof, but is equal to or greater than sizes of a MAC CE on which the Short BSR is transmitted and of a subheader thereof, the terminal device 1 performs a subsequent operation. In a case where data available for transmission on two or more LCGs is present, the Truncated BSR on the LCG that has the highest priority level is reported. In the other cases, the Short BSR is reported.

The uplink BSRs that are all triggered are cancelled in the following cases.

(1) A case where the BSR is included in the MAC PDU

(2) A case where all pieces of uplink data within the buffer are available for transmission on the UL-SCH that is allocated by the uplink grant, but a resource is insufficient for additionally sending the BSR MAC CE and the subheader thereof

Next, a D2D BSR according to the present embodiment will be described below.

With the D2D BSR, an amount of buffer for D2D transmission data on the logical channel that is available for the D2D communication is notified, as the message of the MAC layer, to the base station apparatus. One aspect of the D2D BSR is that with the D2D BSR, an amount of buffer for the transmission data on the logical channel is notified with the logical channel available for the D2D communication as one type. However, in a case where there are two or more types of logical channels that are available for the D2D communication, the amount of buffer for the transmission data on each logical channel or the amount of buffer for the transmission data on every LCG that is made up of two or more types of logical channels may be notified as is the case with the uplink BSR. Furthermore, as is the case with the uplink BSR, the triggering condition for the D2D BSR may be that all of the regular BSR, the periodic BSR, and the padding BSR are used, and that only some of the triggering conditions are used.

FIG. 11 illustrates one example of a constitution of the D2D BSR MAC CE. In FIG. 11, the D2D BSR MAC CE is constituted from 16 bits (two octets), which are a sum of bits for a 2-bit LCG ID field indicating on which LCG the Buffer Status Report is, for a 6-bit buffer size field indicating a buffer size of the LCG; and for an 8-bit group ID field for specifying a group of terminal devices 1 that perform the D2D communication, and it is possible that the Buffer Size Report on one LCG is transmitted.

However, the size of each field that constitutes the MAC CE that is included in the MAC PDU, which is described above, is one example, and other sizes may be used as the sizes of these fields.

A random access procedure according to the present embodiment is described.

The random access procedures are categorized into two procedures, that is, a contention based random access procedure and a non-contention based random access procedure.

The contention based random access procedure is executed when initial access takes place in a state where a connection (communication with) to the base station apparatus 3 is not made, and/or when a scheduling request is made in a case where the uplink data that is available for transmission to the terminal device 1 in a state where the connection to the base station apparatus 3 is made, but uplink synchronization is not adjusted, or the D2D data that is available for transmission occurs, and/or so on.

The occurrence of the uplink data that is available for transmission in the terminal device 1 may include triggering of the Buffer State Report that corresponds to the uplink data that is available for transmission. The occurrence of the uplink data that is available for transmission in the terminal device 1 may include making pending the scheduling request that is triggered based on the occurrence of the uplink data that is available for transmission.

The occurrence of the D2D data that is available for transmission in the terminal device 1 may include triggering of the Buffer State Report that corresponds to the D2D data that is available for transmission. The occurrence of the D2D data that is available for transmission in the terminal device 1 may include making pending the scheduling request that is triggered based on the occurrence of the D2D data that is available for transmission.

For example, the terminal device 1 for which the mode 1 is configured may initiate the contention based random access procedure, in a case where the scheduling request that is triggered based on the occurrence of the uplink data that is available for transmission or the D2D data that is available for transmission is made pending, where the terminal device 1 for which the mode 1 is configured does not have a UL-SCH (PUSCH) resource that is available for transmission, and where the terminal device 1 for which the mode 1 is configured does not have an effective PUCCH resource for the configured scheduling request.

In the following description of the random access procedure, the terminal device 1 for which the mode 1 for the D2D communication is configured by the higher layer is expressed simply as terminal device 1.

The non-contention based random access procedure is used for quickly establishing the uplink synchronization between the terminal device 1 and the base station apparatus 3, in a case where the terminal device 1 uses a procedure that is designated by the base station apparatus 3, and where a connection between the base station apparatus 3 and the terminal device 1 is in progress, but handover or a transmission timing of a mobile station apparatus is not effective.

The contention based random access procedure according to the present embodiment is described.

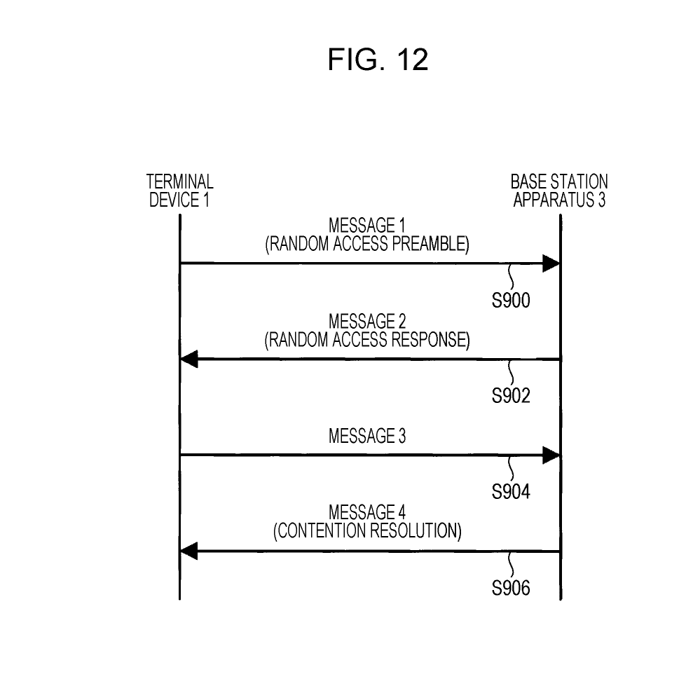

As illustrated in FIG. 12, the contention based random access procedure is realized by reception and transmission of 4 types of messages between the terminal device 1 and the base station apparatus 3.

<Message 1 (S900)>

The terminal device 1 in which the uplink data that is available for transmission or the D2D data that is available for transmission occurs transmits a preamble (which is referred to as a random access preamble) for random access, on a Physical Random Access Channel (PRACH), to the base station apparatus 3. The random access preamble that is transmitted is referred to a message 1 or a Msg 1. The random access preamble is constituted in such a manner that information is notified, with multiple sequences, to the base station apparatus 3. For example, in a case where 64 types of sequences are prepared, 6-bit information can be indicated to the base station apparatus 3. This information is indicated as a Random Access Preamble Identifier.

<Message 2 (S902)>

The base station apparatus 3 that receives the random access preamble generates a random access response that includes the uplink grant for instructing the terminal device 1 to perform the transmission, and transmits the generated random access response to the terminal device 1 on the PDSCH. The random access response is referred to as a message 2 or a Msg 2. Furthermore, the base station apparatus 3 calculates a gap in transmission timing between the terminal device 1 and the base station apparatus 3 from the received random access preamble, and includes transmission timing adjustment information for adjusting the gap, in the message 2. Furthermore, the base station apparatus 3 includes the Random Access Preamble Identifier that corresponds to the received random access preamble, in the message 2. Furthermore, the base station apparatus 3 transmits random access response identification information (RA-RNTI) (Random Access-Radio Network Temporary Identity) for indicating the random access response that is destined for the terminal device 1 which transmits the random access preamble, on the PDCCH. The RA-RNTI is determined depending on positional information on the Physical Random Access Channel on which the random access preamble is transmitted.

<Message 3 (S904)>

The terminal device 1 that transmits the random access preamble performs monitoring of the PDCCH on which the random access response that is identified with the RA-RNTI is transmitted, during multiple subframe durations (which is referred to as a RA response window) after the random access preamble is transmitted. In a case where the RA-RNTI is detected, the terminal device 1 that transmits the random access preamble performs decoding of the random access response that is mapped to the PDSCH. The terminal device 1 that succeeds in the decoding checks whether or not the Random Access Preamble Identifier that corresponds to the random access preamble is included in the random access response, and, in a case where the Random Access Preamble Identifier is included, compensates for a gap in synchronization using the transmission timing adjustment information that is indicated in the random access response. Furthermore, the terminal device 1 transmits data that is retained in a buffer, to the base station apparatus 3, using the uplink grant that is included in the random access response. The data that, at this time, is transmitted using the uplink grant is referred to as a message 3 or a Msg 3.

Furthermore, in a case where the random access response of which the decoding is successful is successfully received for the first time in a sequence of random access procedures, the terminal device 1 includes information for identifying the terminal device 1, in the message 3 that is transmitted. In a case where transmission data that occurs is the uplink data, the information for identifying the terminal device 1 indicates the C-RNTI, and, in a case where the transmission data that occurs is the D2D data, indicates the D2D-RNTI. A type of transmission data that occurs, for example, is identified with a logical channel ID. If an LCID of the logical channel to which the data that occurs belongs is the uplink data, the terminal device 1 transmits the C-RNTI MAC CE to the base station apparatus 3, in a state of being included at the time of subsequent uplink transmission. In a case where the LCID of the logical channel to which the data that occurs belongs is the D2D data, the terminal device 1 transmits the D2D-RNTI MAC CE to the base station apparatus 3, in a state of being included at the time of subsequent uplink transmission. The C-RNTI MAC CE indicates the C-RNTI. The D2D-RNTI MAC CE indicates the D2D-RNTI.

<Message 4 (S906)>

When the uplink transmission is made to the base station apparatus 3 on a resource that is allocated to the message 3 of the terminal device 1 with the random access response, the base station apparatus 3 detects the C-RNTI MAC CE or the D2D-RNTI MAC CE that is included in the received message 3. Then, in a case where the connection to the terminal device 1 is established, the base station apparatus 3 transmits the PDCCH to a destination of the detected C-RNTI or the detected D2D-RNTI. In a case where the PDCCH is transmitted to the destination of the detected C-RNTI, the base station apparatus 3 includes the uplink grant in the PDCCH, and, in a case where the PDCCH is transmitted to the destination of the detected D2D-RNTI, includes in the PDCCH in the D2D grant. Each of the PDCCHs that are transmitted by the base station is referred to as a message 4, a Msg 4, or a contention resolution message.

The terminal device 1 that transmits the message 3 starts a contention resolution timer (mac-ContentionResolutionTimer) which determines a duration during which the message 4 from the base station apparatus 3 is monitored, and attempts to receive the PDCCH that is transmitted from the base station for which a timer is responsible. In a case where the PDCCH destined for the destination of the transmitted C-RNTI is received from the base station apparatus 3 and where the uplink grant for new transmission is included in the PDCCH, the terminal device 1 that transmits the C-RNTI MAC CE with the message 3 regards this as success in Contention Resolution with a different terminal device 1, stops the contention resolution timer, and ends the random access procedure. Furthermore, in a case where the PDCCH destined for the destination of the transmitted D2D-RNTI is received from the base station apparatus 3 and where the D2D grant is included in the PDCCH, the terminal device 1 that transmits the D2D-RNTI MAC CE with the message 3 regards this as the success in the Contention Resolution with the different terminal device 1, stops the contention resolution timer, and ends the random access procedure. In a case where, within a timer duration, the terminal device 1 itself has difficulty in checking whether or not the PDCCH destined for the destination of C-RNTI or the D2D-RNTI that is transmitted with the message 3 is received, the terminal device 1 regards this as failure in the Contention Resolution, again performs transmission of the random access preamble, and continues the random access procedure. However, in a case where the transmission of the random access preamble is repeated a prescribed number of times and where the Contention Resolution is not successful, it is determined that there is a problem with the random access and the higher layer is instructed to execute a random access program. For example, the higher layer may set a MAC entity based on the random access program. In a case where resetting of the MAC entity is requested by the higher layer, the terminal device 1 stops the random access procedure.

With the transmission and reception of the four messages, which are described above, the terminal device 1 can establish synchronization with the base station apparatus 3 and can perform uplink data communication with the base station apparatus 3 or D2D data communication in the mode 1 with a different terminal device 1.

However, in a case where, in the terminal device 1, both of the uplink data that is available for transmission and the D2D data that is available for transmission occurs, the terminal device 1 and the base station apparatus 3 may perform any of the random access procedures that are described in an operational example 1 to an operational example 5 that follow. That, in a case where, in the terminal device 1, the random access procedure is started based on the scheduling request for the uplink data that is available for transmission and on the scheduling request for the D2D data that is available for transmission, the terminal device 1 and the base station apparatus 3 may perform any one of the random access procedures that are described in the operational example 1 to the operational example 5 that follow.

Furthermore, in a case where, in the terminal device 1, the uplink data that is available for transmission does not occur and where the D2D data that is available for transmission occurs, the terminal device 1 and the base station apparatus 3 may perform any of the random access procedures that are described in the operational example 1 to the operational example 5 that follow. That is, in a case where, in the terminal device 1, the random access procedure is started on the scheduling request for the D2D data that is available for transmission, not based on the scheduling request for the uplink data that is available for transmission, the terminal device 1 and the base station apparatus 3 may perform any one of the random access procedures that are described in the operational example 1 to the operational example 5 that follow.

Furthermore, a random access procedure that is executed in a case where both of the uplink data that is available for transmission and the D2D data that is available for transmission occurs in the terminal device 1, and a random access procedure that is executed in a case where the D2D data that is available for transmission does not occur in the terminal device 1 may be the same and may be different from each other.

### OPERATIONAL EXAMPLE 1

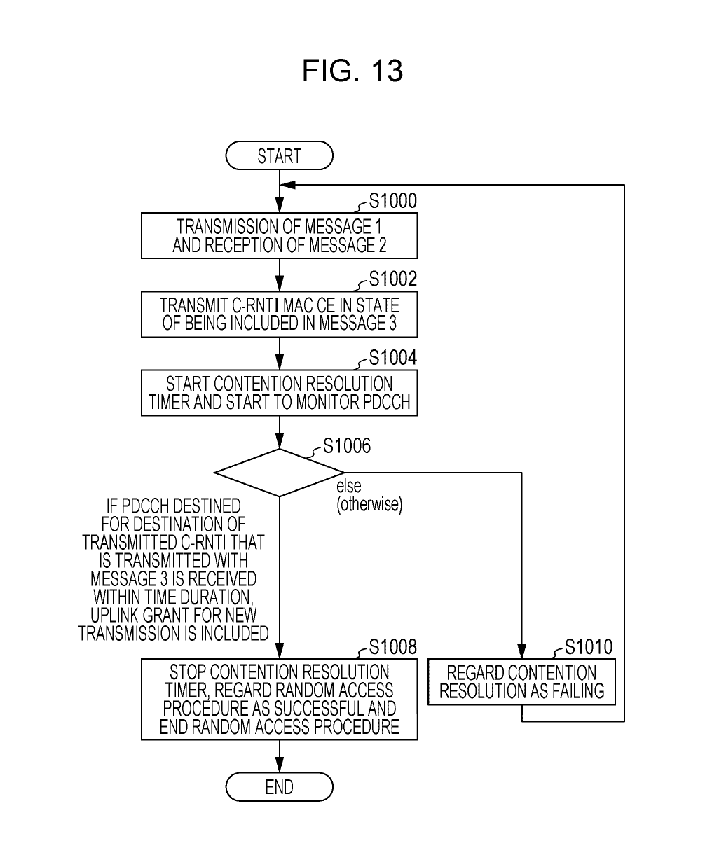

FIG. 13 is a block diagram illustrating a procedure for the operational example 1 of the terminal device 1. The terminal device 1 in which both of the uplink data and the D2D data (or only the D2D data) occur performs the transmission and reception of the message 1 and the message 2, which are described above (S1000), and then transmits the C-RNTI MAC CE indicating the C-RNTI that identifies the terminal device 1, to the base station apparatus 3, in a state of being included in the message 3 (S1002). Then, the terminal device 1 starts the contention resolution timer and starts to monitor the PDCCH from the base station apparatus 3 (S1004). In a case where, within a duration of the contention resolution timer, the PDCCH destined for the destination of the C-RNTI that is transmitted with the message 3 is detected and where the uplink grant for new transmission is successfully detected (Yes in S1006), the terminal device 1 stops the contention resolution timer, and regards the random access procedure as successful and stops the random access procedure (S1008). In the other cases (in a case where a contention resolution timer expires) (No in S1006), contention resolution is regarded as failing, returning to S1000 takes place (S1010).

### OPERATIONAL EXAMPLE 2

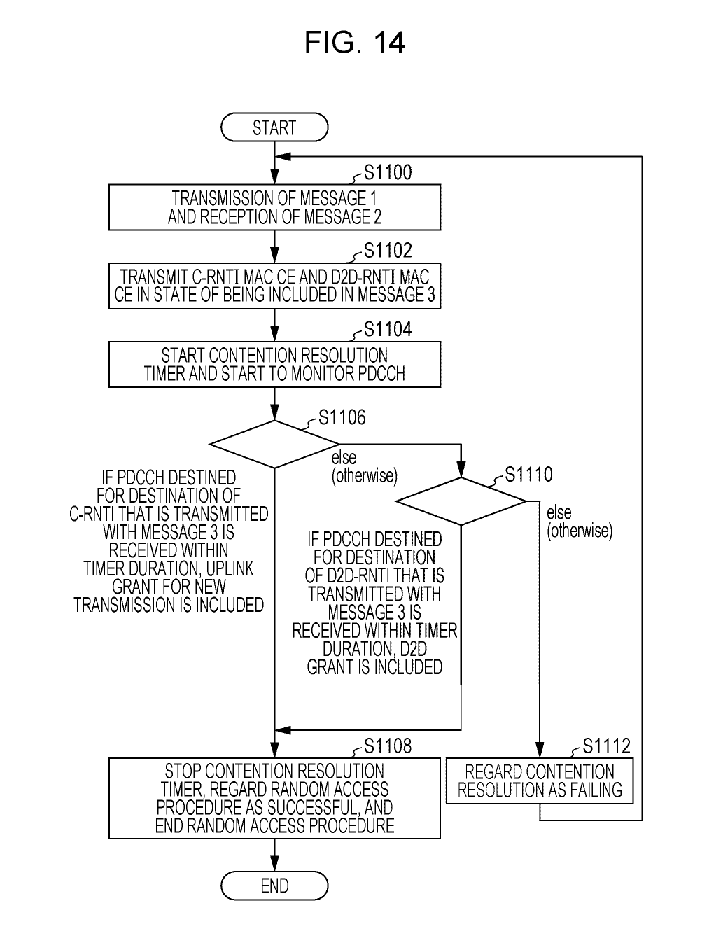

FIG. 14 is a block diagram illustrating a procedure for the operational example 2 that is another operational example of the terminal device 1 according to the present embodiment. The terminal device 1 in which both of the uplink data and the D2D data (or only the D2D data) occur performs the transmission and reception of the message 1 and the message 2, which are described above (S1100), and then transmits both of the C-RNTI MAC CE indicating the C-RNTI that identifies the terminal device 1 and the D2D-RNTI MAC CE indicating the D2D-RNTI, to the base station apparatus 3, in a state of being included in the message 3 (S1102). Then, the terminal device 1 starts the contention resolution timer and starts to monitor the PDCCH from the base station apparatus 3 (S1104). In a case where, within the duration of the contention resolution timer, the PDCCH destined for the destination of the C-RNTI that is transmitted is detected and where the uplink grant for new transmission is successfully detected (Yes in S1106), the contention resolution timer is stopped, and the random access procedure is regarded as successful and the random access procedure is stopped (S1108). In the other cases (No in S1006), if, within the duration of the contention resolution timer, the PDCCH destined for the destination of the D2D-RANI that is transmitted is detected and the D2D grant is successfully detected (Yes in S1110), proceeding to S1108 takes place. In a case where the result is NO in any of S1106 and S1110, the contention resolution is regarded as failing, and returning to S1100 takes place (S1112). Moreover, the order in which determination in Step S1106 and determination in Step S1110 are made may be reversed. Moreover, the determination in Step S1106 and the determination in Step S1110 may be made at the same time. However, the D2D grant that is a detection target in S1110 may be regarded as the D2D grant for new communication, and may be regarded as the D2D grant for new transmission and/or re-transmission.

### OPERATIONAL EXAMPLE 3

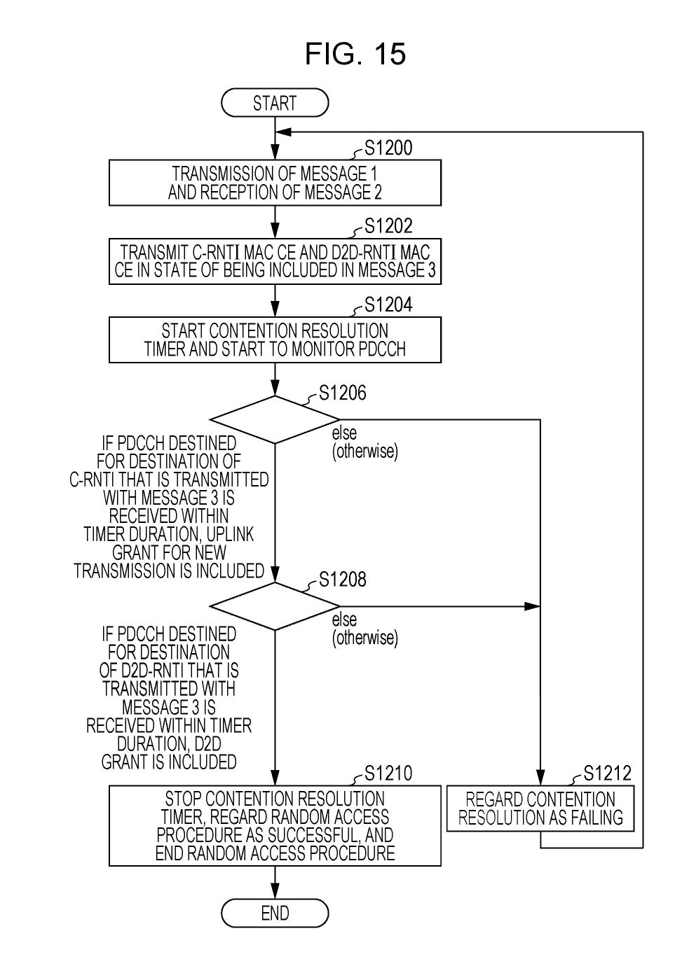

FIG. 15 is a block diagram illustrating a procedure for the operational example 3 that is another operational example of the terminal device 1 according to the present embodiment. The terminal device 1 in which both of the uplink data and the D2D data (or only the D2D data) occur performs the transmission and reception of the message 1 and the message 2, which are described above (S1200), and then transmits both of the C-RNTI MAC CE indicating the C-RNTI that identifies the terminal device 1 and the D2D-RNTI MAC CE indicating the D2D-RNTI, to the base station apparatus 3, in a state of being included in the message 3 (S1202). Then, the terminal device 1 starts the contention resolution timer and starts to monitor the PDCCH from the base station apparatus 3 (S1204). In the case where, within the duration of the contention resolution timer, the PDCCH destined for the destination of the C-RNTI that is transmitted is detected and where the uplink grant for new transmission is successfully detected (Yes in S1206), and in a case where the PDCCH destined for the destination of the D2D-RNTI that is transmitted within the timer duration is detected and where the D2D grant is successfully detected (Yes in S1208), the contention resolution timer is stopped, and the random access procedure is regarded as successful and the random access procedure is stopped (S1210). In a case where it is difficult to detect any one of the uplink grant for new transmission destined for the destination of the transmitted C-RNTI and the D2D grant destined for the destination of the transmitted D2D-RNTI (No in S1206 or No in S1208), the contention resolution is regarded as failing, and returning to S1200 takes place (S1212). However, the D2D grant that is the detection target in S1208 may be regarded as the D2D grant for new communication, and may be regarded as the D2D grant for new transmission and/or re-transmission.

### OPERATIONAL EXAMPLE 4

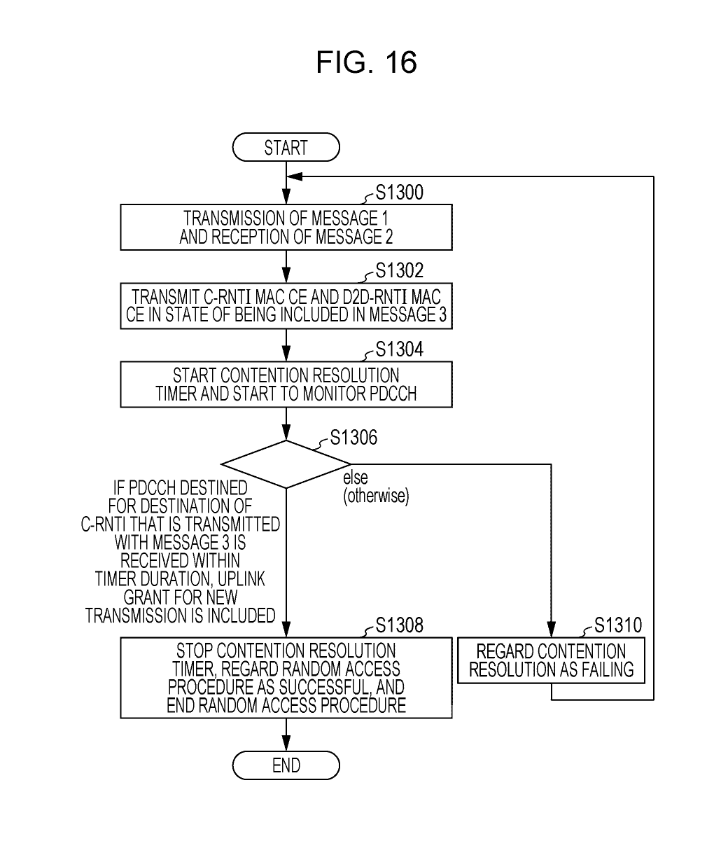

FIG. 16 is a block diagram illustrating a procedure for the operational example 4 that is another operational example of the terminal device 1 according to the present embodiment. The terminal device 1 in which both of the uplink data and the D2D data (or only the D2D data) occur performs the transmission and reception of the message 1 and the message 2, which are described above (S1300), and then transmits both of the C-RNTI MAC CE indicating the C-RNTI that identifies the terminal device 1 and the D2D-RNTI MAC CE indicating the D2D-RNTI, to the base station apparatus 3, in a state of being included in the message 3 (S1302). Then, the terminal device 1 starts the contention resolution timer and starts to monitor the PDCCH from the base station apparatus 3 (S1304). In a case where, within the timer duration, the PDCCH destined for the destination of the C-RNTI that is transmitted with the message 3 is detected and where the uplink grant for new transmission is successfully detected (Yes in S1306), the contention resolution timer is stopped, and the random access procedure is regarded as successful and the random access procedure is stopped (S1308). In the other cases (No in S1306), the contention resolution is regarded as failing, and returning to S1300 takes place (S1310). In a case where the D2D grant destined for the destination of the transmitted D2D-RNTI is successfully detected, the random access procedure continues until the uplink grant destined for the destination of the transmitted C-RNTI is successfully detected, without the contention resolution timer stopping.

### OPERATIONAL EXAMPLE 5

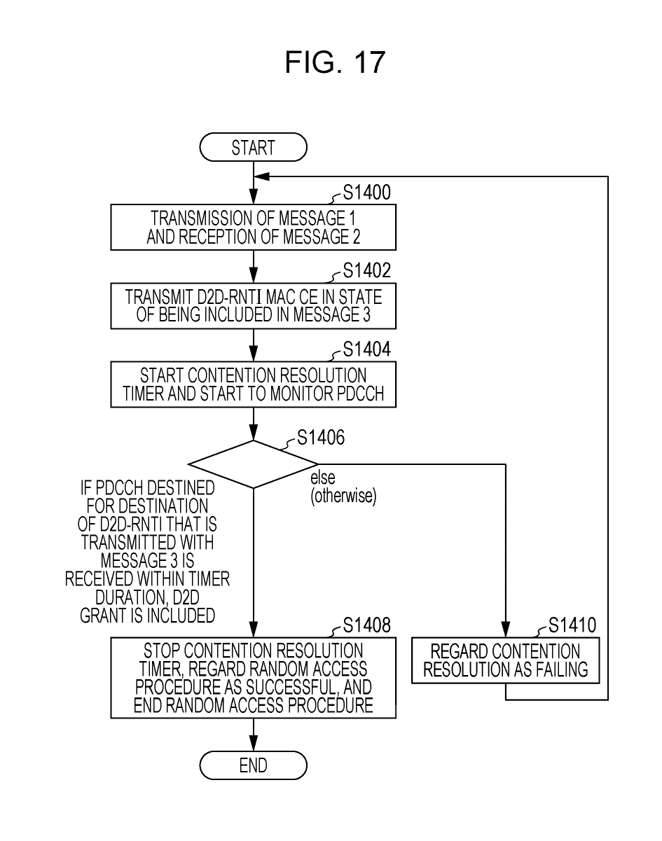

FIG. 17 is a block diagram illustrating a procedure for the operational example 5 that is another operational example of the terminal device 1 according to the present embodiment. The terminal device 1 in which both of the uplink data and the D2D data (or only the D2D data) occur performs the transmission and reception of the message 1 and the message 2, which are described above (S1400), and then transmits the D2D-RNTI MAC CE indicating the D2D-RNTI that identifies the terminal device 1, to the base station apparatus 3, in a state of being included in the message 3 (S1402). Then, in a case where the terminal device 1 starts the contention resolution timer and starts to monitor the PDCCH from the base station apparatus 3 (S1404), and where, within the timer duration, the terminal device 1 detects the PDCCH destined for the destination of the D2D-RNTI that is transmitted with the message 3 and succeeds in the detection of the D2D grant (Yes in S1406), the contention resolution timer is stopped, and the random access procedure is regarded as successful and the random access procedure is ended (S1408). In the other cases (No in S1406), the contention resolution is regarded as failing, and returning to S1400 takes place (S1410). However, the D2D grant that is the detection target in S1406 may be regarded as the D2D grant for new communication, and may be regarded as the D2D grant for new transmission and/or re-transmission.

However, the terminal device 1 in which both of the uplink data and the D2D data (or only the D2D data) occur may be constituted in such a manner that any one of the operational example 1 to the operation example 5, which are described above, is selected for the terminal device 1 to operate.

However, in the random access procedure that is described above, in a case where the LCID of the logical channel to which the data that occurs belongs is the D2D data, an aspect in which the D2D-RNTI MAC CE is transmitted in the message 3 is described, but in the message 3, the terminal device 1 may transmit information indicating the D2D group ID. As the information indicating the D2D group ID, the D2D group ID MAC CE may be used, and the D2D BSR MAC CE may be used. In a case where the connection to the terminal device 1 is established, the base station apparatus 3 that detects the information indicating the D2D group ID in the received message 3 transmits the D2D grant including the detected information indicating the D2D group ID, as the message 4, on the PDCCH. In a case where the D2D grant is included in the PDCCH that is received from the base station apparatus 3, and where the information indicating the D2D group ID, which is transmitted with the message 3, is included in the D2D grant, the terminal device 1 that transmits the information indicating the D2D group ID with the message 3 regards this as success in the contention resolution with a different terminal device 1, and stops the content resolution timer and ends the random access procedure. However, the D2D grant that is a target may be regarded as the D2D grant for new communication, and may be regarded as the D2D grant for new transmission and/or re-transmission.

A constitution of the device according to the present embodiment will be described below.

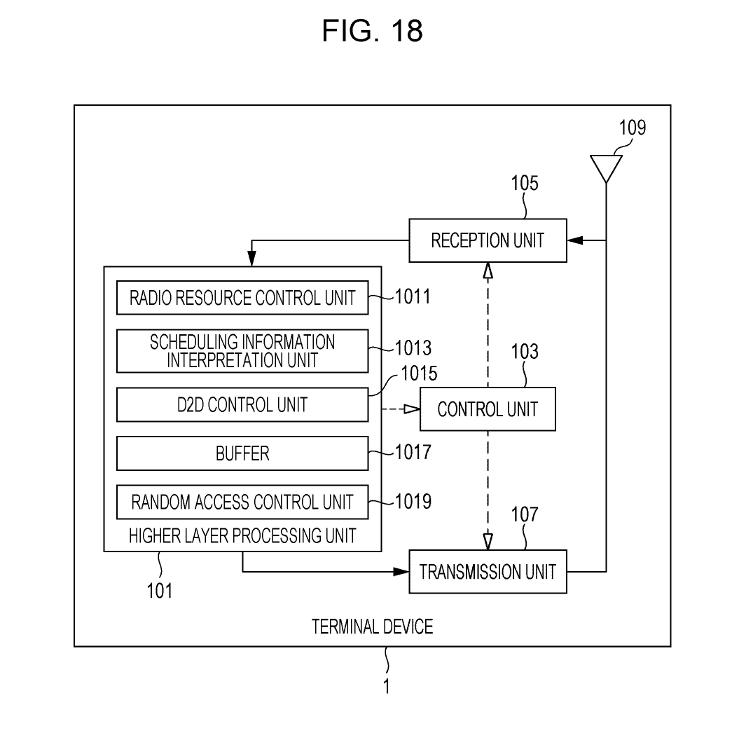

FIG. 18 is a schematic block diagram illustrating a constitution of the terminal device 1 according to the present embodiment. As illustrated, the terminal device 1 is constituted to include a higher layer processing unit 101, a control unit 103, a reception unit 105, a transmission unit 107, and a transmit and receive antenna unit 109. Furthermore, the higher layer processing unit 101 is constituted to include a radio resource control unit 1011, a scheduling information interpretation unit 1013, a D2D control unit 1015, a buffer 1017, and a random access control unit 1019.

The higher layer processing unit 101 outputs the uplink data that is generated by a user operation and the like, to the transmission unit 107. Furthermore, the higher layer processing unit 101 performs processing of a Medium Access Control (MAC) layer, a Packet Data Convergence Protocol (PDCP) layer, a Radio Link Control (RLC) layer, and a Radio Resource Control (RRC) layer.

The radio resource control unit 1011 that is included in the higher layer processing unit 101 manages various pieces of configuration information of the terminal device 1 itself or various parameters for the terminal device 1 itself. The radio resource control unit 1011 sets various pieces of configuration information/parameters based on the higher layer signal that is received from the base station apparatus 3. That is, the radio resource control unit 1011 sets various pieces of configuration information/parameters based on pieces of information indicating various pieces of configuration information/parameters that are received from the base station apparatus 3. Furthermore, the radio resource control unit 1011 generates information that is mapped to each channel in the uplink and outputs the generated information to the transmission unit 107.

The scheduling information interpretation unit 1013 that is included in the higher layer processing unit 101 interprets the DCI format (the scheduling information) that is received through the reception unit 105, generates control information for performing control of the reception unit 105 and the transmission unit 107 based on a result of interpreting the DCI format, and outputs the generated control information to the control unit 103.

The D2D control unit 1015 that is included in the higher layer processing unit 101 performs control of the D2D discovery, the D2D communication, and/or ProSe-assisted WLAN direct communication, based on various pieces of configuration information/parameters that are managed by the radio resource control unit 1011. The D2D control unit 1015 may generate information that is associated with the D2D, which is transmitted to a different terminal device 1 or the EUTRAN (the base station apparatus 3).

The buffer 1017 that is included in the higher layer processing unit 101 includes an uplink data buffer, a D2D data buffer, and a message 3 buffer, in which the uplink data that is transmitted to the base station apparatus 3, the D2D data that is transmitted to a different terminal device 1, and the message 3 that is transmitted to the base station apparatus 3 are retained, respectively. In a case where the uplink grant is detected in the scheduling information interpretation unit 1013, the uplink data and the message 3 that are retained are output to the transmission unit 107. Furthermore, in a case where the mode 1 for the D2D communication is configured, if the D2D grant is detected in the scheduling information interpretation unit 1013, the retained D2D data is output to the transmission unit 107. In a case where the mode 2 for the D2D communication is configured, under the instruction of the control unit 103, the retained D2D data is output to the transmission unit 107.

In a case where the random access procedure is executed, the random access control unit 1019 that is included in the higher layer processing unit 101 selects the random access preamble that is used in the random access procedure, and outputs the selected random access preamble to the transmission unit 107. Furthermore, the random access control unit 1019 detects the random access response that includes the Random Access Preamble Identifier which corresponds to the transmitted random access preamble, from the base station apparatus 3 through the reception unit 105, and, in a case where the uplink grant is included in the random access response, outputs the control information to the control unit 103 through the scheduling information interpretation unit 1013. In this case, if the uplink data is retained in the buffer 1017, data that includes information indicating the C-RNTI is retained, as the message 3, in the buffer 1017, and if the D2D data is retained in the buffer 1017, data that includes information indicating the D2D-RNTI is retained, as the message 3, in the buffer 1017.

Furthermore, in a case where the information indicating the C-RNTI is transmitted as the message 3, if the PDCCH destined for the destination of the C-RNTI is detected from a signal that is received in the reception unit 105, the random access control unit 1019 ends the random access procedure. Furthermore, in a case where the information indicating the D2D-RNTI is transmitted as the message 3, if the PDCCH destined for the destination of the D2D-RNTI is detected from the signal that is received in the reception unit 105, the random access control unit 1019 ends the random access procedure.

The control unit 103 generates a control signal for performing the control of the reception unit 105 and the transmission unit 107, based on control information from the higher layer processing unit 101. The control unit 103 outputs the generated control signal to the reception unit 105 and the transmission unit 107, and performs the control of the reception unit 105 and the transmission unit 107.

In accordance with the control signal that is input from the control unit 103, the reception unit 105 demultiplexes, demodulates, and decodes a reception signal that is received from the base station apparatus 3 or a different terminal device 1 through the transmit and receive antenna unit 109, and outputs information that results from the decoding, to the higher layer processing unit 101.

The transmission unit 107 generates the uplink reference signal in accordance with the control signal, which is input from the control unit 103, performs the coding and the modulation on the uplink data (the transport block), which is input from the higher layer processing unit 101, multiplexes the PUCCH, the PUSCH, and the generated uplink reference signal, and transmits a result of the multiplexing to the base station apparatus 3 through the transmit and receive antenna unit 109.

Furthermore, in accordance with the control signal that is input from the control unit 103, the transmission unit 107 codes and modulates the D2D data that is input from the higher layer processing unit 101, and transmits a result of the coding and modulation to a different terminal device 1 through the transmit and receive antenna unit 109.

Furthermore, in the random access procedure, the transmission unit 107 codes and modulates the random access preamble that is input from the higher layer processing unit 101, or the message 3 that is input from the higher layer processing unit 101, and transmits a result of the coding and modulation to the base station apparatus 3 through the transmit and receive antenna unit 109.

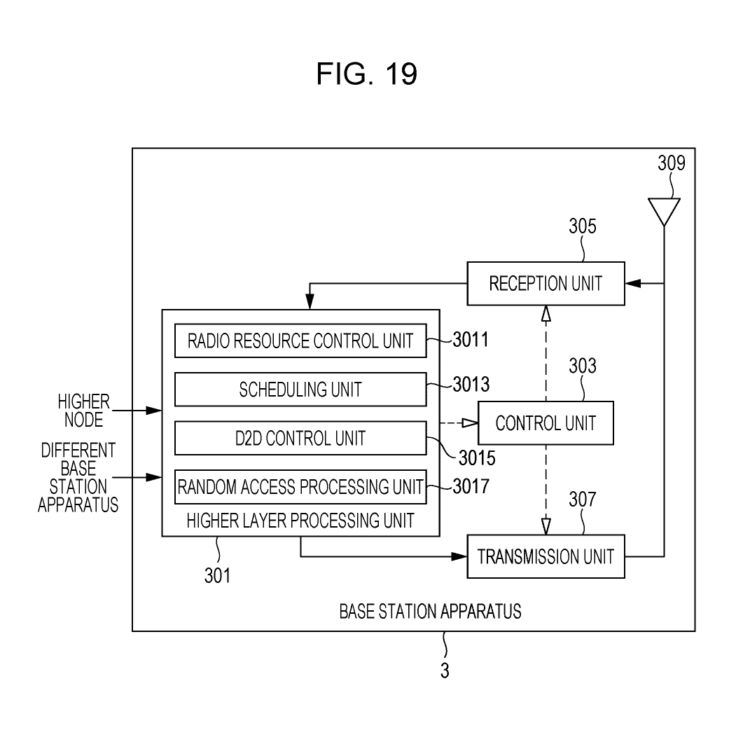

FIG. 19 is a schematic block diagram illustrating a constitution of the base station apparatus 3 according to the present embodiment. As illustrated, the base station apparatus 3 is constituted to include a higher layer processing unit 301, a control unit 303, a reception unit 305, a transmission unit 307, and a transmit and receive antenna unit 309. Furthermore, the higher layer processing unit 301 is constituted to include a radio resource control unit 3011, a scheduling unit 3013, a D2D control unit 3015, and a random access processing unit 3017.

The higher layer processing unit 301 performs the processing of the Medium Access Control (MAC) layer, the Packet Data Convergence Protocol (PDCP) layer, the Radio Link Control (RLC) layer, and the Radio Resource Control (RRC) layer. Furthermore, the higher layer processing unit 301 generates a control signal in order to perform control of the reception unit 305 and the transmission unit 307, and outputs the generated control information to the control unit 303.

The radio resource control unit 3011 that is included in the higher layer processing unit 301 generates, or acquires from a higher level node, the downlink data (the transport block) that is mapped to the PDSCH in the downlink, system information, the RRC message, a MAC Control Element (CE), and the like, and outputs a result of the generation or of the acquirement to the transmission unit 307. Furthermore, the radio resource control unit 3011 manages various pieces of configuration information of each of the terminal devices 1 or various parameters for each of the terminal devices 1. The radio resource control unit 1011 may set various pieces of configuration information/parameters for each of the terminal devices 1 through the higher layer signal. That is, the radio resource control unit 1011 transmits/broadcasts pieces of information indicating various pieces of configuration information/parameters.

The scheduling unit 3013 that is included in the higher layer processing unit 301 determines a frequency and a subframe to which the physical channel (the PDSCH and the PUSCH) is allocated, the coding rate and the modulation scheme for the physical channel (the PDSCH and the PUSCH), the transmit power, and the like, from the received channel state information and from the channel estimation value, the channel quality, or the like that is input from the channel measurement unit 3059. The scheduling unit 3013 generates the control information (for example, the DCI format) in order to perform the control of the reception unit 305 and the transmission unit 307 based on a result of the scheduling, and outputs the generated information to the control unit 303. Furthermore, the scheduling unit 3013 determines a timing when the transmission processing and reception processing are performed.

The D2D control unit 3015 that is included in the higher layer processing unit 301 performs control of the D2D discovery, the D2D communication, and/or the ProSe-assisted WLAN direct communication in the terminal device 1 that performs the communication using the cellular link, based on various pieces of configuration information/parameters that are managed by the radio resource control unit 3011. The D2D control unit 3015 may generate the information that is associated with the D2D, which is transmitted to a different base station apparatus 3 or the terminal device 1.

The random access processing unit 3017 that is included in the higher layer processing unit 301 detects the random access preamble from the terminal device 1, which is received in the reception unit 305, and in a case where the connection to the terminal device 1 is made, generates the random access response that includes the Random Access Preamble Identifier which corresponds to the received random access preamble, and transmits the generated random access response to the transmission unit 307.

Furthermore, the random access processing unit 3017 detects the message 3 from the terminal device 1, which is received in the reception unit 305. In a case where the information indicating the C-RNTI is included in the detected message 3, the contention resolution message that includes the uplink grant destined for the destination of the C-RNTI is generated and the generated contention resolution message is output to the transmission unit 307. In a case where the information indicating the D2D-RNTI is included in the detected message 3, the contention resolution message that includes the D2D grant destined for the destination of the D2D-RNTI is generated and the generated contention resolution message is output to the transmission unit 307.

The control unit 303 generates a control signal for performing the control of the reception unit 305 and the transmission unit 307, based on control information from the higher layer processing unit 301. The control unit 303 outputs the generated control signal to the reception unit 305 and the transmission unit 307, and performs the control of the reception unit 305 and the transmission unit 307.

The transmission unit 307 generates the downlink reference signal in accordance with the control signal that is input from the control unit 303, codes and modulates the HARQ indicator, the Downlink Control Information, and the downlink data that are input from the higher layer processing unit 301, multiplexes the PHICH, the PDCCH, the EPDCCH, the PDSCH, and the downlink reference signal, and transmits the resulting signal to the terminal device 1 through the transmit and receive antenna unit 309.

A terminal device 1 according to the present embodiment, which is a terminal device 1 that communicates with a different terminal device 1 and a base station apparatus 3 (a EUTRAN), a transmission unit 107 that transmits a signal to the different terminal device 1 and the base station apparatus 3, a reception unit 105 that receives the signal from the base station apparatus 3, a buffer 1017 that retains data which is transmitted from the transmission unit 107, and a higher layer processing unit 101 that processes a random access procedure, in which the transmission unit 107 transmits a random access preamble from the transmission unit 107 to the base station apparatus 3, and in which, in a case where a random access response that corresponds to the random access preamble is received in the reception unit 105, and where data that is to be transmitted to the different terminal device 1 is retained in the buffer 1017, the higher layer processing unit 101 performs processing in such a manner that information indicating a D2D-RNTI is included in a message 3 that is to be transmitted from the transmission unit 107 to the base station apparatus 3.

In the case where the random access response that corresponds to the random access preamble is received in the reception unit 105, and where the data that is available for transmission to the different terminal device 1 is retained in the buffer 1017, the higher layer processing unit 101 described above may perform processing in such a manner that information indicating a D2D group ID is included in the message 3.

In a case where the random access response that corresponds to the random access preamble is received in the reception unit 105, and where the data that is available for transmission to the base station apparatus 3 is retained in the buffer 1017, the higher layer processing unit 101 described above may perform processing in such a manner that information indicating a C-RNTI is included in the message 3.

In a case where a PDCCH destined for a destination of the D2D-RNTI is detected from a signal that is received in the reception unit 105, and where the PDCCH is included in a D2D grant, the higher layer processing unit 101 described above may end the random access procedure.

In a case where the PDCCH destined for the destination of the D2D-RNTI is detected from the signal that is received in the reception unit 105, and where the D2D grant that belongs to the D2D group ID is included in the PDCCH, the higher layer processing unit 101 described above may end the random access procedure.

In a case where the PDCCH destined for the destination of the C-RNTI is detected from the signal that is received in the reception unit 105, and where the PDCCH is included in the uplink grant for new transmission, the higher layer processing unit 101 described above may end the random access procedure.

In a case where a PDCCH destined for a destination of the D2D-RNTI is detected from a signal that is received in the reception unit 105, and where the PDCCH is included in a D2D grant, the higher layer processing unit 101 described above may end the random access procedure.

In a case where a first PDCCH destined for the destination of the C-RNTI and a second PDCCH destined for the destination of the D2D-RNTI are detected from the signal that is received from the reception unit 105, where the first PDCCH is included in the uplink grant for the new transmission, and where the second PDCCH includes the D2D grant, the higher layer processing unit 101 may end the random access procedure.

A base station apparatus 3 according to the present embodiment, which is a base station apparatus 3 that communicates with a terminal device 1, includes a reception unit 305 that receives a message 3 which includes information indicating a D2D-RNTI, from the terminal device 1, a higher layer processing unit 301 that performs processing in such a manner that a PDCCH destined for a destination of the D2D-RNTI includes a D2D grant for new transmission, and a transmission unit 307 that transmits the PDCCH to the terminal device 1.

The reception unit 305 described above may receive information indicating a D2D group ID with the message 3, and the higher layer processing unit 301 described above may perform processing in such a manner that the information indicating the D2D group ID is included in the D2D grant.

Accordingly, the D2D can be efficiently performed between the terminal devices 1. Furthermore, the base station apparatus 3 can efficiently control the D2D between the terminal devices 1 using the cellular link.

A program running on the base station apparatus 3 and the terminal device 1 according to the present invention may be a program (a program for causing a computer to operate) that controls a Central Processing Unit (CPU) and the like in such a manner as to realize the functions according to the embodiments of the present invention, which are described above. Then, pieces of information that are handled in these devices temporarily accumulate in a Random Access Memory (RAM) while being processed. Thereafter, the pieces of information are stored in various types of ROMs such as a Flash Read Only Memory (ROM), or a Hard Disk Drive (HDD), and if need arises, are read by the CPU to be modified or written.

Moreover, one portion of each of the terminal device 1 and the base station apparatus 3 according to the embodiments, which are described above, may be realized by the computer. In such a case, the portion may be realized by recording a program for realizing such a control function on a computer-readable medium and causing a computer system to read the program recorded on the recording medium for execution.

Moreover, the “computer system” here is defined as a computer system that is built into the terminal device 1 or the base station apparatus 3 and as including an OS or hardware components such as a peripheral device. Furthermore, the “computer-readable recording medium” refers to a portable medium, such as a flexible disk, a magneto-optical disk, a ROM, and a CD-ROM, and a storage device, such as a hard disk, that is built into the computer system.

Moreover, the “computer-readable recording media” may include a medium that dynamically retains the program for a short period of time, such as a communication line that is available when transmitting the program over a network such as the Internet or over a communication network such as a telephone network, and a medium that retains the program for a fixed period of time, such as a volatile memory within the computer system, which functions as a server or a client in a case where the program is retained dynamically for a short period of time. Furthermore, the program may be one for realizing some of the functions described above and may be one that can realize the functions described above in combination with a program that is already recorded on the computer system.

Furthermore, the base station apparatus 3 according to the embodiment, which is described above, can be realized as an aggregation (an apparatus group) that is constituted from multiple apparatuses. Each of the apparatuses that constitute the apparatus group may be equipped with some portions or all portions of each function of, or some portions or all portions of each functional block of the base station apparatus 3 according to the embodiment, which is described. The apparatus group itself may have each general function of or each general functional block of the base station apparatus 3. Furthermore, it is also possible that the terminal device 1 according to the embodiments, which is described, communicates with the base station apparatuses as an aggregation.

Furthermore, the base station apparatus 3 according to the embodiment, which is described, may be the Evolved Universal Terrestrial Radio Access Network (EUTRAN). Furthermore, the base station apparatus 3 according to the embodiment, which is described above, may have some portions or all portions of a function of a node that is at a higher level than an eNodeB.

Furthermore, some portions or all portions of each of the terminal device 1 and the base station apparatus 3 according to the embodiment, which are described above, may be realized as an LSI that is a typical integrated circuit and may be realized as a chip set. Each functional block of each of the terminal device 1 and the base station apparatus 3 may be individually realized into a chip, and some or all of the functional blocks may be integrated into a chip. Furthermore, a circuit integration technique is not limited to the LSI, and an integrated circuit for the functional block may be realized as a dedicated circuit or a general-purpose processor. Furthermore, if with advances in semiconductor technology, a circuit integration technology for a circuit with which an LSI is replaced will appear, it is also possible that an integrated circuit to which such a technology applies is used.

Furthermore, according to the embodiments, which are described above, the terminal device is described as one example of a communication device, but the present invention is not limited to this, and can also be applied to a terminal device or a communication apparatus, such as a fixed-type electronic apparatus that is installed indoors or outdoors, or a stationary-type electronic apparatus, for example, an AV apparatus, a kitchen apparatus, a cleaning or washing machine, an air conditioner, office equipment, a vending machine, and other household apparatuses.

The embodiments of the invention are described in detail above referring to the drawings, but the specific constitution is not limited to the embodiments and also includes an amendment to a design and the like that fall within the scope that does not depart from the gist of the present invention. Furthermore, various modifications are possible within the scope of the present invention defined by claims, and embodiments that are implemented by suitably combining technical means that are disclosed according to different embodiments also fall within the technical scope of the present invention. Furthermore, a configuration in which a constituent element that achieves the same effect is substituted for the one that is described above according to each embodiment described above also falls within the technical scope of the present invention.

### INDUSTRIAL APPLICABILITY

Several aspects of the present invention can be applied to a terminal device, a base station apparatus, an integrated circuit, a wireless communication method, and the like, in all of which D2D communication signal need to be efficiently performed.

### REFERENCE SIGNS LIST

1 (1A, 1B, 1C) TERMINAL DEVICE

3 BASE STATION APPARATUS

101 HIGHER LAYER PROCESSING UNIT

103 CONTROL UNIT

105 RECEPTION UNIT

107 TRANSMISSION UNIT

109 TRANSMIT AND RECEIVE ANTENNA UNIT

301 HIGHER LAYER PROCESSING UNIT

303 CONTROL UNIT

305 RECEPTION UNIT

307 TRANSMISSION UNIT

309 TRANSMIT AND RECEIVE ANTENNA UNIT

1011 RADIO RESOURCE CONTROL UNIT

1013 SCHEDULING INFORMATION INTERPRETATION UNIT

1015 D2D CONTROL UNIT

1017 BUFFER

1019 RANDOM ACCESS CONTROL UNIT

3011 RADIO RESOURCE CONTROL UNIT

3013 SCHEDULING UNIT

3015 D2D CONTROL UNIT

3017 RANDOM ACCESS PROCESSING UNIT

1. A terminal device that communicates with a different terminal device and a base station apparatus, comprising:
a transmission unit that transmits a signal to the different terminal device and the base station apparatus;
a reception unit that receives the signal from the base station apparatus;
a buffer that retains data which is transmitted from the transmission unit; and
a higher layer processing unit that processes a random access procedure,
wherein the transmission unit transmits a random access preamble to the base station apparatus, and
wherein, in a case where a random access response that corresponds to the random access preamble is received in the reception unit, and where data that is available for transmission to the different terminal device is retained in the buffer, the higher layer processing unit performs processing in such a manner that information indicating a C-RNTI is included in a message 3 that is to be transmitted from the transmission unit to the base station apparatus, on a Physical Uplink Shared Channel that corresponds to the random access response.

2. The terminal device according to claim 1,
wherein, in the case where the random access response that corresponds to the random access preamble is received in the reception unit, and where the data that is available for the transmission to the different terminal device is retained in the buffer, the higher layer processing unit performs processing in such a manner that information indicating a D2D group ID is included in the message 3.

3. The terminal device according to claim 1,
wherein, in a case where a Physical Downlink Control Channel destined for a destination of the C-RNTI is detected from the signal that is received from the reception unit, and where the Physical Downlink Control Channel includes an uplink grant for new transmission, the higher layer processing unit ends a random access procedure.

4. The terminal device according to claim 2,
wherein, in a case where a Physical Downlink Control Channel destined for a destination of the C-RNTI is detected from the signal that is received from the reception unit, and where the Physical Downlink Control Channel includes a D2D grant that belongs to the D2D group ID, the higher layer processing unit ends a random access procedure.

5. A base station apparatus that communicates with a terminal device, comprising:
a reception unit that receives a message 3 which includes information indicating a C-RNTI and information indicating a D2D group ID, from the terminal device;
a higher layer processing unit that performs processing in such a manner that a Physical Downlink Control Channel destined for a destination of the C-RNTI includes an uplink grant for new transmission; and
a transmission unit that transmits the Physical Downlink Control Channel to the terminal device.

6.-8. (canceled)

9. A wireless communication method that is used in a terminal device that communicates with a different terminal device and a base station apparatus, comprising:
retaining data that is to be transmitted to the different terminal device and the base station apparatus;
transmitting a random access preamble to the base station apparatus; and
performing processing in such a manner that, in a case where a random access response that corresponds to the random access preamble is received and where data that is available for transmission to the different terminal device is retained, information indicating a C-RNTI is included in a message 3 that is to be transmitted to the base station apparatus, on a Physical Uplink Shared Channel that corresponds to the random access response.

10. The wireless communication method according to claim 9,
wherein, in a case where a Physical Downlink Control Channel destined for a destination of the C-RNTI is detected from the signal that is received from the base station apparatus, and where the Physical Downlink Control Channel includes an uplink grant for new transmission, a random access procedure is ended.

11. A wireless communication method that is used in a base station apparatus that communicates with a terminal device, comprising:
receiving a message 3 that includes information indicating a C-RNTI and information indicating a D2D group ID, from the terminal device;
performing processing in such a manner that transmission of a Physical Downlink Control Channel destined for a destination of the C-RNTI includes an uplink grant for new transmission; and
transmitting the Physical Downlink Control Channel to the terminal device.
